(19) United States
(12) Patent Application Publication
(10) Pub. No.: US 2015/0029583 A1
(43) Pub. Date: Jan. 29, 2015

(54) Apparatus and Method for Transmitted Light Illumination for Light Microscopes and Microscope System

(71) Applicant: Carl Zeiss Microscopy GmbH, Jena (DE)

(72) Inventor: Detlef Hein, Goettingen (DE)

(21) Appl. No.: 14/345,339

(22) PCT Filed: Aug. 16, 2012
(86) PCT No.: PCT/EP2012/003497

§ 371 Date: Oct. 10, 2014

(30) Foreign Application Priority Data
Sep. 23, 2011 (DE) 102011114377.0

(51) Int. Cl. G02B 21/06

(52) U.S. Cl. CPC G02B 21/06
USPC 359/390

(57) ABSTRACT

The invention relates to an apparatus for transmitted light illumination for light microscopes, in particular stereo microscopes or macroscopes. The apparatus has a light source for emitting an illuminating light beam, and a holding device for holding a sample to be examined, wherein a deflection device is provided between the light source and the holding device for contrast adjustment, wherein an angle distribution of the illuminating light bundle relative to an optical axis can be varied with the deflection device. The apparatus is characterized in that the deflection device comprises a prism film. The invention also relates to a method for transmitted light illumination for light microscopes and a microscope system.

The present invention relates in a first aspect to a device for transmitted light illumination for light microscopes, in particular stereo microscopes or macroscopes, according to the preamble to claim 1.

According to another aspect, the invention relates to a method for transmitted light illumination for microscopes, in particular stereo microscopes or macroscopes, according to the preamble to claim 14. In addition the invention relates to a microscope system.

A generic apparatus for transmitted light illumination for light microscopes is described for example in EP 1 591 821 A1 and comprises a light source to emit an illuminating light beam and a holding device for holding a sample to be examined. Furthermore, a deflection device is provided between the light source and the holding device for contrast adjustment. The deflection device allows to vary an angle distribution of the illumination light bundle relative to an optical axis.

In a generic method a sample held by a holding device is exposed to illuminating light from a light source and an angle distribution of an illuminating light bundle is varied with a deflection unit for contrast variation.

EP 1 591 821 A1 describes a transmitted light device with a transparent object table which is illuminated with an illuminating area that functions as a light source. Between the light source and the object table a deflection device is arranged which limits the light propagation in at least one direction. A suitable choice of size of the arrangement described in EP 1 591 821 A1 shall assist in achieving a contrast improvement.

DE 10 2004 056 685 A1 describes a lighting device with two pivotable diaphragms. The pivot point of the diaphragms is thereby fixed and cannot be displaced. In addition there are no means for detecting, storing and/or reproducing the illumination settings of the pivotable diaphragms or pre-settings automatically adapted to the object. The lighting device described in DE 10 2004 056 685 A1 therefore lacks ease of use.

U.S. Pat. No. 7,133,199 B2 describes a structured illumination element for adapting the illumination to two channels. The main propagating directions of the deflected illuminating light coincides in each case with the axes of the two channels.

In JP 2007017901 A2 a transmitted light basis for stereo and mono observation with switching through a beam splitter film is disclosed.

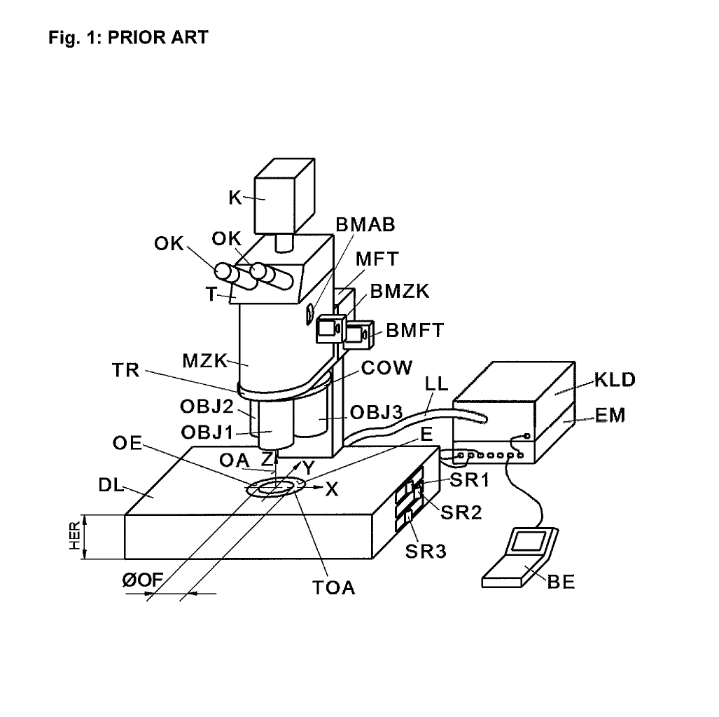

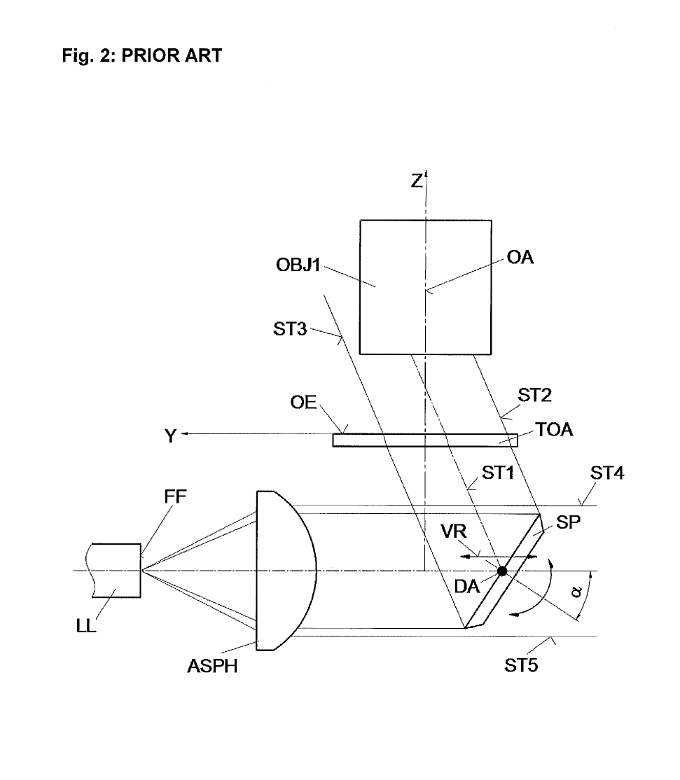

The prior art is explained in more detail using FIGS. 1 and 2.

FIG. 1 shows a typical stereo microscope arrangement according to the prior art. A transmitted light device DL illuminates the object field with a diameter OF, located in the plane OE, which is identified by the highest lying surface of the transmitted light device DL. On the transmitted light device DL there is a motorised focussing device MFT which can be operated by means of an operating unit BMFT and on which a carrier TR with a coded objective changer (COW) is arranged. By means of the objective changer COW, three objectives OBJ1, OBJ2, OBJ3 can be used with different properties. For example the objective OBJ2 has, besides a further objective magnification with the smallest zoom factor β, also an entrance pupil which clearly lies at a greater distance from the object plane OE than the other two objectives. In FIG. 1, BMAB identifies an operating element for a motorised aperture diaphragm MAP. A plane at the level of the object support on the transmitted light device is identified by an E. MFT identifies a motorised focussing device.

On the carrier TR, there is a motorised zoom body MZK which can be used via an operating unit BMZK. On the motorised zoom body MZK there is an objective barrel T, with which the stereo microscope image can be observed directly by the two oculars OK. In addition the objective barrel T also facilitates documentation of the images seen by means of a connected camera K.

The transmitted light means DL according to the prior art which is not motorised is supplied with light by a cold light source KLD via a fibre optic light conductor LL. It has three manually settable operating elements SR1, SR2, SR3 for varying the light settings.

The whole system is controlled by the electronic module EM and the operating unit BE connected thereto. Communication within the whole system is achieved for example by means of a CAN bus.

For further observation, a coordinate system with the coordinate axes X, Y and Z is introduced. The coordinate origin lies in the centre of the object plane OE. For reasons of simplification, in this illustration the focus is on the upper side of the transparent object support TOA, that is to say OE is identical to the upper side of the transparent object support TOA and lies in the plane which spans across the coordinate axes X and Y. The positive half axes point, as seen by the user, in the following directions: X to the right, Y to the rear, Z upwards. The Z axis is identical to the optical axis OA of the momentarily connected objective.

For stereomicroscopes and macroscopes, there are numerous transmitted light illumination methods which cannot provide a suitable illumination for all possible imaging conditions, this being mainly due to the zoom function of the zoom body MZK. This applies in particular to the region of overview, that is to say for the smaller zoom factors of the zoom body. The lighting of stereo microscopes and macroscopes is frequently homogenised with suitable means, for example with milk glasses. This does indeed allow the homogeneity of the lighting to be improved but the contrast decreases correspondingly due to the light distribution across large spatial angle regions and the detrimental scattering light increases. The correspondingly illuminated overview images thus provide only very poor contrast. Many details can only be recognised with larger zoom factors β. The required zooming-in and zooming-out thereby require a long time and the overview is lost during the zoom process with larger zoom factors β.

FIG. 2 shows the operating principle of a known transmitted light device DL from FIG. 1. The front area FF of the light conductor LL is approximately imaged at infinity by means of an asphere ASPH. This means that the light beams output from a common point of the front area FF of the light conductor extend behind the asphere in parallel. By way of example, FIG. 2 shows the light beams ST1 ST2, ST3, ST4 and ST5 starting from a common point on the light conductor LL. Behind the asphere ASPH there is a deflection mirror SP which can be moved or rotated in different directions via the three operating elements SR1, SR2, SR3 shown in FIG. 1.

By means of the operating unit SR1, the mirror SP is rotated about the rotation axis DA as far as the desired adjustment angle α, whereby the light beams contacting the deflection mirror SP can be deflected in the respective directions. The operating unit SR2 allows the deflection mirror SP to be moved together with the rotation axis DA in the displacement direction VR. The light beams reflected by the deflection mirror SP thereby enter, in dependence upon the mirror position, at various points through the transparent object support TOA and the object plane OE.

By means of the operating element SR3, the deflection mirror SP is moved in the X direction, thus perpendicular to the illustration plane. Without changing the mirror geometry, another mirror surface is thereby effectively created with deviating reflection properties. None of the two usable mirror surfaces has 100% reflection orientation, that is to say they reflect with scattering diffusion, wherein the scattering proportion of the two mirror surfaces differs. In order to achieve illumination which is as homogeneous as possible, the greater scattering mirror surface is to be used, whereby the contrast is impaired and the image brightness decreases. A rotationally symmetric transmitted light bright field illumination can be achieved if the deflection mirror SP is adjusted such that the main beam, i.e. the light beam ST1, enters the objective OBJ1 exactly along the optical axis OA of the objective. This is the case if the setting angle α=45° and the impinging spot of the light beam ST1 is on the deflection mirror SP on the optical axis OA of the objective OBJ1. The deflection mirror SP redirects in this case the light, which comes from behind from the positive Y direction, upwards in the direction of the positive Z axis.

At the expense of homogeneity, the contrast can increase if the weaker scattering mirror surface is used. This corresponds more to a directed illumination. With larger magnifications a significant contrast enhancement can be reached with a still sufficient homogeneity if an oblique illumination is used. For this end, the deflection mirror SP is rotated and displaced in the displacement direction VR so far that the objective OBJ1 is illuminated in the desired way. A further contrast enhancement can be seen if the mirror edges are used, i.e. if jump-like brightness differences in the illumination can be used for contrast enhancement. This effect, however, only applies in relatively small regions of the object field, that is, homogeneous illuminations for larger overview object fields cannot be realized in this way.

The adjustment of the described illumination parameters requires certain experience to be held by the operator, i.e. untrained users might not have the skills to use the lighting adjustment via the three operating elements SR1, SR2, SR3 without further assistance.

Transmitted light devices DL, which contain an inclinable deflection mirror SP according to FIG. 2 also require a relatively large construction height in order to illuminate larger object fields, this being due to construction reasons. In spite of this, the achievable homogeneity and contrasting is not yet optimal even with a large structural height with this arrangement.

In case of normal light microscopes and some macroscopes, transmitted light illumination methods are known which require a fixed pupil plane. In most cases, then, contrast-increasing elements are brought into the light beam path and/or the imaging beam path, in particular into the objective pupil or a plane conjugated therewith. This requires extremely great resources and can only be achieved, if at all, with great limitations on zoom systems, and thus on stereo microscopes and macroscopes. These conventional methods only function with special objectives with expensive accessories, for example DIC sliders and only in certain zoom regions. The optical design requires unfavourably large installation spaces as well as strain-free optics for polarisation methods. In addition a possibility must be provided in the illumination device for manipulating the contrast-increasing elements and in general also a possibility for adaptation to different sized object fields through exchangeable condenser lenses. These solutions are therefore only suitable for special applications and in addition are expensive.

All solutions according to the prior art require great resources in their realisation and/or leave much to be desired in terms of usability and user-friendliness.

It can be seen as an object of the invention to create an apparatus and a method for transmitted light illumination for light microscopes, which allow for contrast-rich images in transmitted light observation with considerably differing optical setups. In addition, ease of use is to be improved in comparison with the prior art.

This object is achieved according to a first aspect through the device having the features of claim 1.

Having regard to methods, the object is achieved through the method having the features of claim 14. According to the invention, a microscope system having the features of claim 23 is additionally provided.

Advantageous embodiments of the device according to the invention and preferred variants of the method according to the invention are explained below with reference to the dependent claims and in particular in connection with the attached drawings.

The apparatus and the method of the above-mentioned type is further developed according to the invention in that the deflection device comprises a prism film.

In addition protection is claimed for a microscope system which has a light microscope and an apparatus for transmitted light illumination according to the invention.

It can be regarded as a first core idea of the invention to deflect the illuminating light emitted from the light source with a deflection device having a micro prism structure with a plurality of identically working elements. The angle distribution of the illuminating light can thereby be purposefully influenced.

By using a prism film, the possible applications of an apparatus for transmitted light illumination with a planar light source can be significantly increased. In particular, the contrast can be variably set. Clear improvements in the imaging quality are possible in particular for low-contrast samples.

The method according to the invention can be realised in particular with the apparatus for transmitted light illumination according to the invention. For this, a control device is present in an advantageous variant of the microscope system according to the invention, said control device being connected to components of the light microscope and the apparatus for transmitted light illumination and being adapted to control the microscope and the apparatus for transmitted light illumination to realise a method according to the invention.

The advantages according to the invention, thus in particular clear improvements in the contrast, are achieved in a particular way if the prisms of the prism film point in the direction of the light source.

According to a particularly preferred embodiment of the apparatus according to the invention a main deflection direction of the deflection device, thus essentially of the prism film, is different from the optical axis. An inclined light illumination is thus achieved, with which good increases in contrast are possible.

Having regard to the details, the achievable contrast improvements depend upon the optical parameters of the prism film, thus of the individual prisms. Extensive trials have shown here that particularly good results are possible if the prisms of the prism film have a prism angle of 20° to 30°, preferably 24° to 28° and particularly preferably 26°.

The achievable increases in contrast depend, in specific terms, greatly upon the respective sample. According to further advantageous variants of the apparatus according to the invention the deflection device can thus be rotated about a rotation axis orientated transversely to the optical axis. This means that the inclined light illumination can be realised from different angles relative to the sample to be examined. The rotation axis is usefully thereby selected so that it is orientated parallel to the direction of the prism edges.

The variability of the transmitted light illumination can be further increased if means for variable positioning of the deflection device in a direction transversely to the optical axis and/or in the direction of the optical axis are present. In particular, the angle of an inclined light illumination can be varied with such means.

For cases in which an illumination of the sample to be examined via the prism film is not useful and/or not desired, means can then be present to move the deflection device out of an optical path of the illuminating light and to move the deflection device into the optical path of the illuminating light.

In this connection, the functionality of the apparatus according to the invention can be further increased if at least one diaphragm edge is present to trim the illuminating light bundle, wherein the diaphragm edge is arranged between the holding device and the light source and extends transversely to an optical axis, in particular of an objective, of a light microscope, which can be positioned in an operating state on the apparatus for transmitted light illumination. The optical path of the illuminating light between the diaphragm edge and a sample held by the holding device can thereby be free in particular of adjustable beam-focussing components. In addition, in order to adapt the optical path of the illuminating light to an effective entrance pupil of the objective, means are present for variable positioning of the diaphragm edge in the direction of the optical axis and a position of the diaphragm edge is variable in the direction of the optical axis, in particular independently of a position of the diaphragm edge transversely to the optical axis.

This development is based upon the core idea of trimming the illuminating light emitted from the light source with a diaphragm edge, wherein the diaphragm edge can be adjusted in the direction of the optical axis in dependence upon the position of the effective entrance pupil of the optical system.

Illuminating light which enters the optical system from locations outside of the entrance pupil, thus the microscope objective, cannot contribute there in the transmitted light brightness field image to the image itself but instead only to the scattered background. This is undesirable and gives rise to a further advantageous method variant, in which an illuminating area of the light source is adapted to an actually effective back-projection of the illuminating light. This means that parts of the illuminating area which cannot provide illuminating light contributing to the image are filtered out at the start. To this end, according to the apparatus according to the invention, at least one further diaphragm is advantageously present, which may be positioned directly in front of the light source.

According to a particularly advantageous variant of the apparatus according to the invention, the diaphragm edge is an edge of a mechanical diaphragm and the deflection device with the prism film is formed on the mechanical diaphragm. In order to provide the diaphragm functionality the mechanical diaphragm has at least one light-impermeable sub-region. A highly functional system can thus be provided, wherein, for different optical situations, either the diaphragm edge and/or the prism film can be used.

Based thereupon are further advantageous variants of the method according to the invention, in which the diaphragm edge is moved out of the optical path of the illuminating light and the deflection device is moved into the optical path of the illuminating light if an effective entrance pupil of the objective lies outside of a region accessible for the diaphragm edge. The operating comfort for a user can hereby be increased if the settings of the deflection device, of the at least one diaphragm edge and/or of further diaphragms, can be realised in an automated manner, in particular following user input.

With regard to the imaging quality and the contrast of the specimen, the results achieved depend strongly on the spatial position of the diaphragm edge as the illumination can be strongly varied and adjusted with the diaphragm edge.

In a particularly preferred embodiment of the inventive device for displacement of the diaphragm edge in the direction of the optical axis and the direction transverse to the optical axis, for instance, a carriage mechanism with a first carriage and a second carriage is present. For driving these carriages, step motors can be used which allow a precise positioning.

According to a further advantageous embodiment of the apparatus according to the invention, at least one further variably positionable diaphragm is present to trim the illuminating light beam between the holding device and the light source. With such a further diaphragm, which can comprise in particular a linear diaphragm edge, further improvements can be achieved having regard to the reduction of scattered light. In addition it can be useful for certain positions of the entrance pupil to have a further variably positionable diaphragm.

In this context, a further preferred variant of the inventive apparatus resides in that a first mechanical diaphragm and a second mechanical diaphragm are provided, in that the diaphragm edge is formed by an edge of the first mechanical edge or by an edge of the second mechanical diaphragm, and in that for displacement of the diaphragm edge in direction of the optical axis and in a direction transverse to the optical axis, a first carriage mechanism with a first carriage and a second carriage for the first mechanical diaphragm and a second carriage mechanism with a third carriage and a fourth carriage for the second mechanical diaphragm are provided. With this arrangement, the effective diaphragm edge can be adjusted variably to different positions of the entrance pupil.

Having regard to the light source to be used it is indeed only a question of the principal function that light is provided with a desired spectral composition in a desired intensity. Having regard to an arrangement which is as compact as possible in structural terms, in particularly preferred variants of the apparatuses according to the invention, planar light sources, in particular a plurality of light diodes, are used. White light LEDS are particularly advantageous having regard to construction size and light output. So-called PHLOX light sources can be used particularly preferably.

Having regard to the method, it is preferred for this purpose that an illuminating light bundle emitted from the light source is trimmed by a diaphragm edge arranged between the holding device and the light source, wherein in particular an optical path of the illuminating light between the diaphragm edge and the sample held by the holding device is free of adjustable beam-focussing components and wherein the diaphragm edge extends transversely to an optical axis of the objective and is positioned in dependence upon the position of the effective entrance pupil of the objective in the direction of the optical axis of the objective.

According to a further advantageous variant of the method according to the invention the diaphragm edge can accordingly be positioned in a direction transversely to the optical axis in order to set the contrast. For this, suitable means for variable positioning of the diaphragm edge in a direction transversely to the optical axis are particularly preferably present in the apparatus according to the invention for transmitted light illumination.

The advantages according to the invention are achieved in a particular way if the diaphragm edge is positioned in a plane of the effective entrance pupil of the objective.

It is particularly preferred that settings of the at least one diaphragm edge, of further diaphragms and/or further optical components are automatically set dependent on a determined configuration of present components, in particular optical components. For example, it can be automatically ascertained which objective is active and which zoom position is set and, in principle, which microscope type is used.

For this end, a microscope system according to the invention is equipped with a memory device in which settings of the transmitted light device and the light microscope, in particular of the deflection device and/or the at least one diaphragm edge, are saved.

According to a particularly simple variant there are no beam-focussing components between the diaphragm edge and the sample, in particular no beam-forming components.

The term “optical axis” is intended in the present description to mean essentially and as a rule the optical axis of an objective of a light microscope which is arranged or positioned in an operating state on the apparatus according to the invention for transmitted light illumination.

If the connected light microscope is a stereo microscope with mid-light beams LM and RM inclined relative to each other, the term “optical axis” can mean:
i) the optical axis of the objective in the case in which the objective only symmetrically detects an observation channel;
ii) the angle bisector between the two mid-light beams if the two observation channels are detected through the objective, or, however,
iii) the mid-light beam of only one channel if only one observation channel is not symmetrically detected.

The term “optical axis” can thus also be defined having regard to the apparatus according to the invention for transmitted light illumination itself in the sense that essentially the direction is meant, in which the illuminating light is radiated. In the usual case the apparatus for transmitted light illumination according to the invention is formed as a substantially flat box which lies for example on a laboratory table. In this case the optical axis points in the direction of the vertical direction, thus in the Z direction.

The term “holding device” is to be functionally interpreted for the purposes of the present invention, i.e. each means is meant, with which a sample to be examined can in some way be positioned and fixed relative to the illuminating light beam and the optics of a light microscope to be connected.

The term “effective entrance pupil” is to be interpreted in terms of phenomenon. Accordingly it is not a calculated or theoretical entrance pupil of the optical system, but instead in fact the region, in which a waist of the illuminating light beam has a minimum cross section, wherein with the illuminating light beam only beam portions are meant that actually contribute to the imaging. This plane region, in the present case referred to as the effective entrance pupil, is determined by measuring, thus testing. In practice the position of this effective entrance pupil depends on the optics used and also upon the sample examined and sample holders such as object carriers or other transparent sample supports and in case of usual zoom microscopes is not a well-defined flat plane.

The angle of inclination of the deflection device, essentially therefore the angle of inclination of the prism film against the optical axis, is an essential parameter for setting the contrast and hence the imaging quality. Extensive trials have hereby shown that this angle of inclination is particularly advantageously adapted to a respectively set combination of objective, zoom body and zoom factor. The illumination can thus be adapted very variably to different optical situations and samples to be examined.

For ergonomic reasons it is preferable for the deflection device to be inclined in operation in such a way that the illuminating light bundle is tilted away from a user. Dazzling can thereby be avoided.

According to a particularly preferred variant of the method according to the invention the diaphragm edge is positioned in a plane of an effective entrance pupil of the objective. In particular the diaphragm edge can be arranged in a direction transversely to the optical axis in such a way that it just contacts the entrance pupil in a direction transversely to the optical axis. An advantageous technical effect is thereby achieved in that a considerable part of the illuminating light, which could have contributed to the scattered light without the diaphragm is now filtered out.

The positioning of the diaphragm edge in the plane of the entrance pupil thus opens up the possibility of achieving an inclined light illumination in that the diaphragm edge covers a part of the entrance pupil. It is particularly preferable for the diaphragm edge to trim the illuminating light bundle asymmetrically in these embodiments. This means that certain rays of the illuminating light are selected and result in an inclined light illumination. In practice, advantageous improvements in contrasting can thus be achieved.

According to a further advantageous embodiment of the method according to the invention, the diaphragm edge can accordingly be positioned in a direction perpendicular to the optical axis in order to set the contrast. According to the apparatus according to the invention for transmitted light illumination, it is particularly preferable for suitable means for variable positioning of the diaphragm edge in a direction perpendicular to the optical axis to be present.

Further advantages and features of the apparatus according to the invention, the method according to the invention and the microscope system according to the invention are explained below by reference to the drawing, in which:

FIG. 1: shows a microscope system according to the prior art;

FIG. 2: shows a sketch to illustrate a transmitted light device according to the prior art;

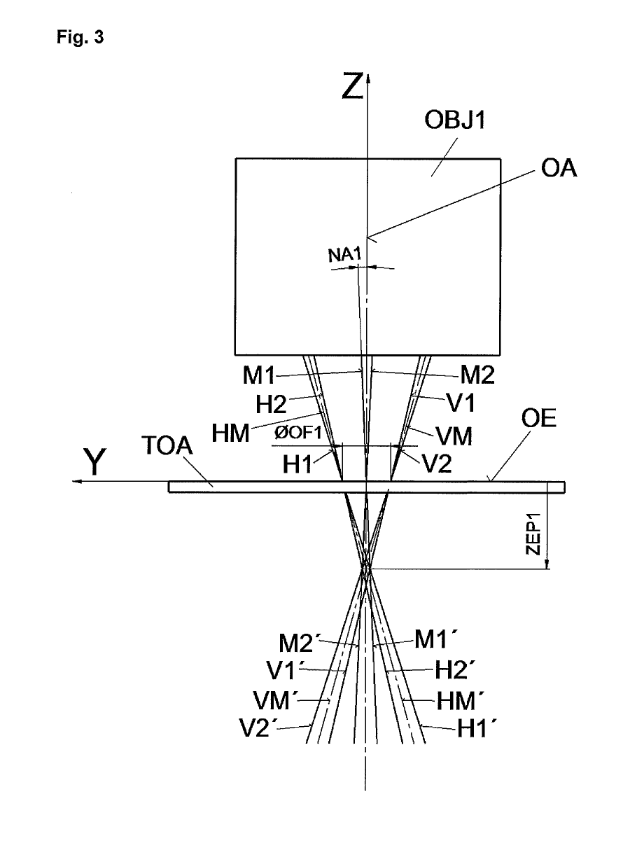

FIG. 3: shows an overview of essential components of the beam path in an apparatus with a first objective according to the invention in a side view;

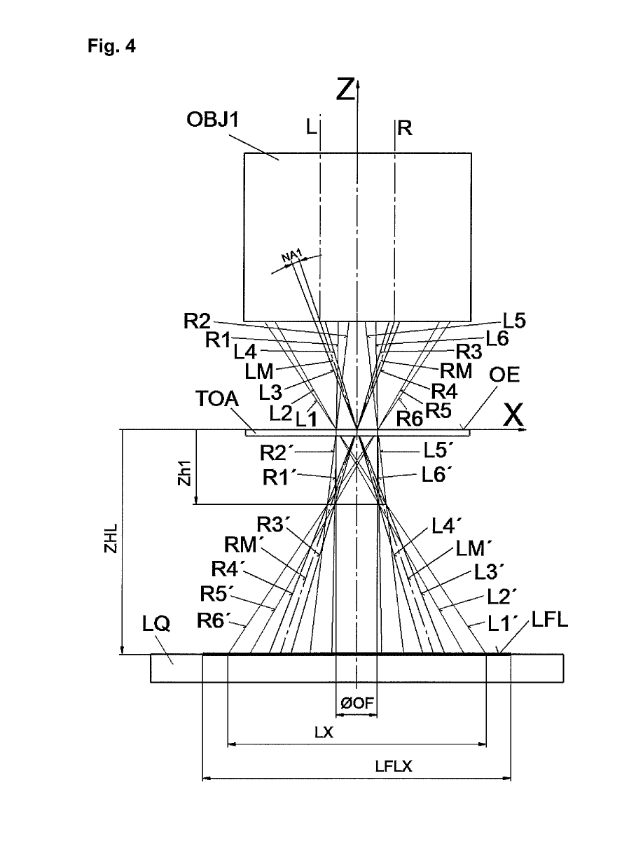

FIG. 4: shows essential components of the beam path in an apparatus according to the invention in a front view;

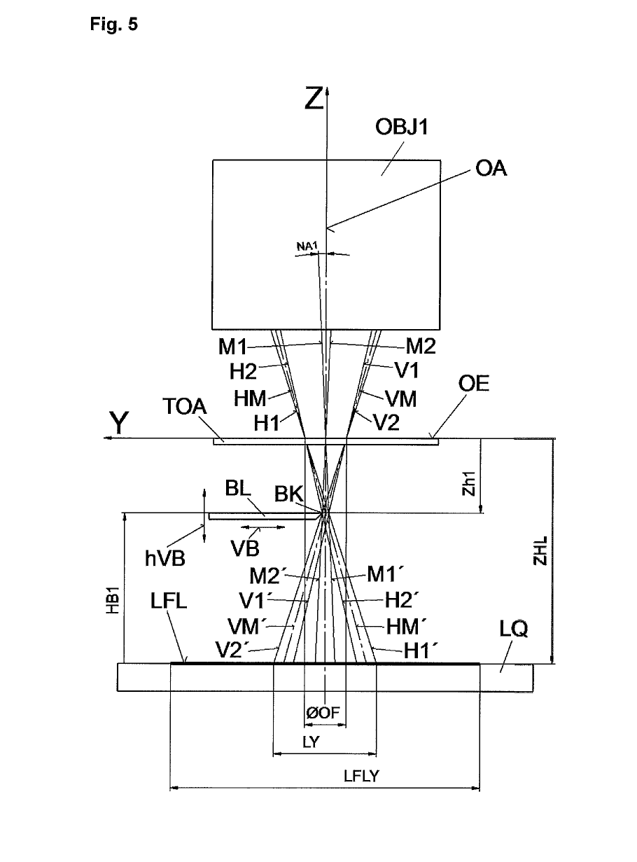

FIG. 5: shows essential components of the beam path in an apparatus according to the invention, which is inserted into a stereo microscope, in a side view with a diaphragm edge;

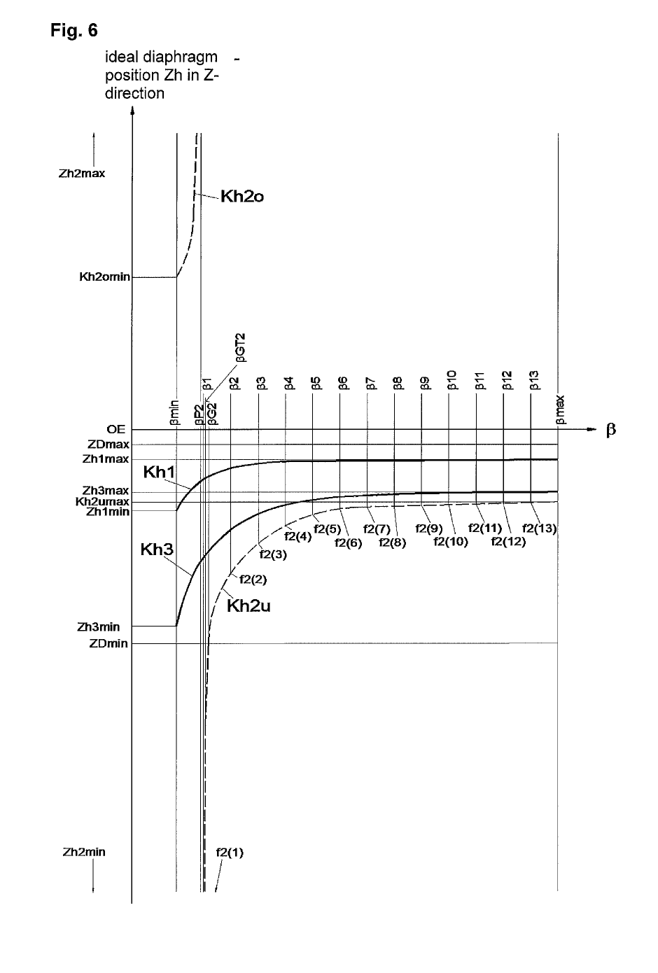

FIG. 6: shows a diagram, in which the optimal positions for the diaphragm edge are shown in dependence upon the zoom factor;

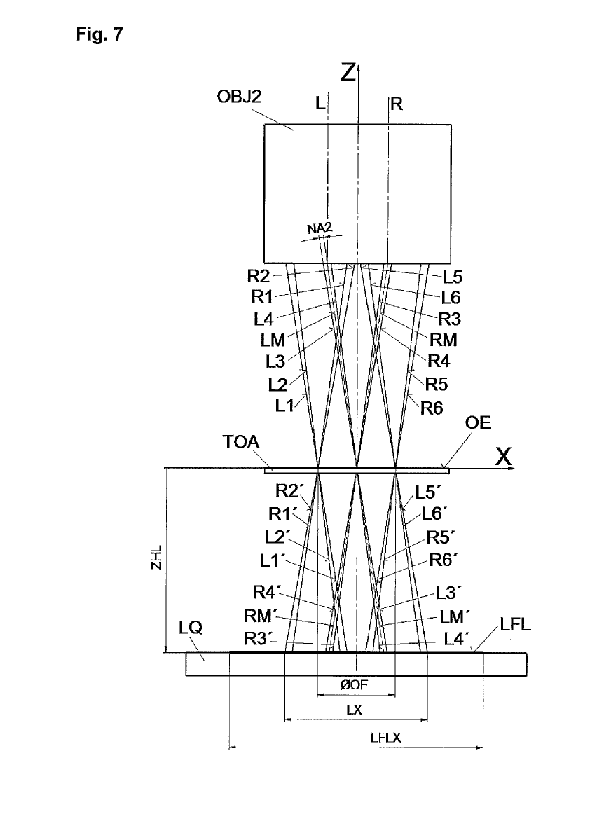

FIG. 7: shows, in a front view, a schematic illustration of edge beams of an objective in a situation, for which the use according to the invention of a prism film is suited;

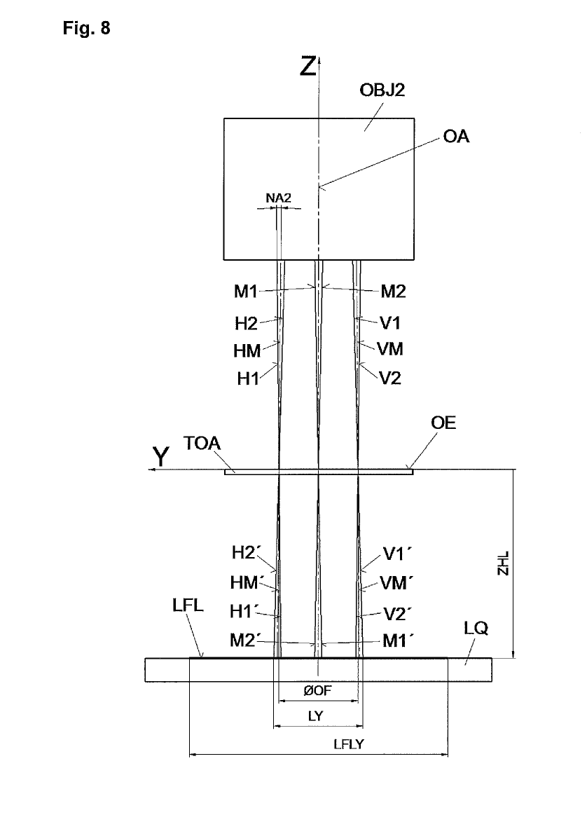

FIG. 8: shows, in a side view, a schematic illustration of edge beams for an objective in a situation, for which the use according to the invention of a prism film can be suitably applied;

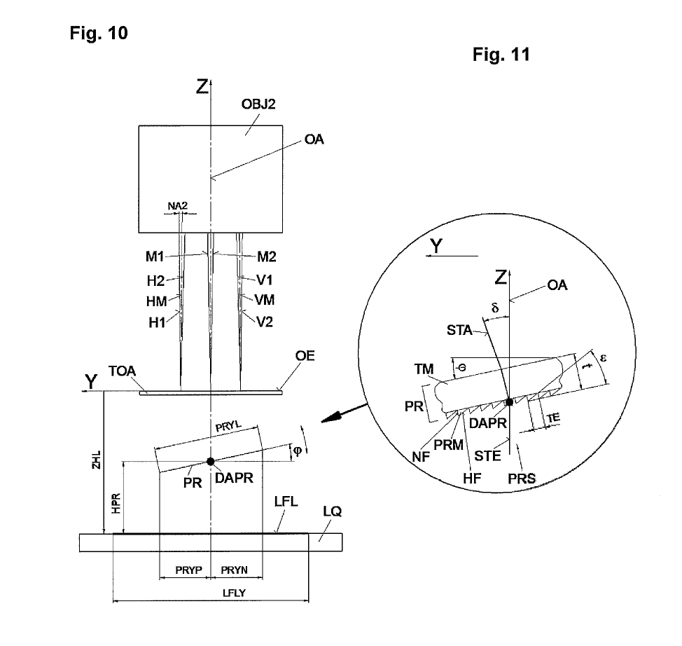

FIG. 10: shows a schematic sketch to illustrate the working principle of the prism film;

FIG. 11: shows a detailed view of FIG. P10;

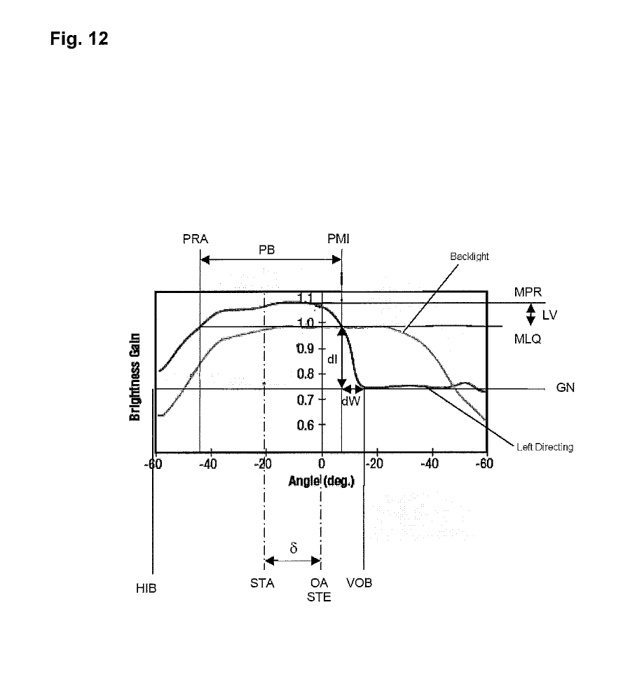

FIG. 12: shows a diagram clarifying light distributions measured with and without prism film;

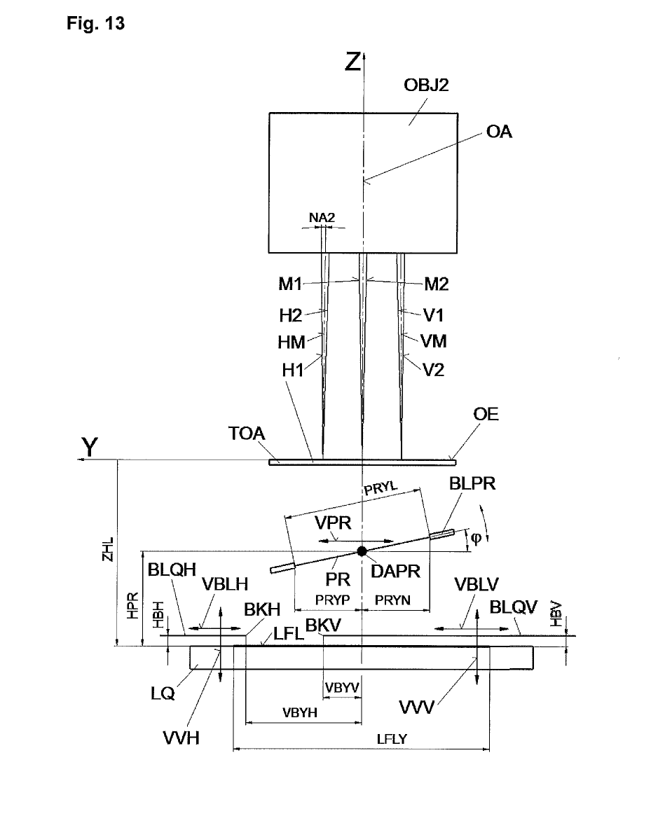

FIG. 13: shows an exemplary embodiment of an apparatus according to the invention with a prism film and two additional diaphragms;

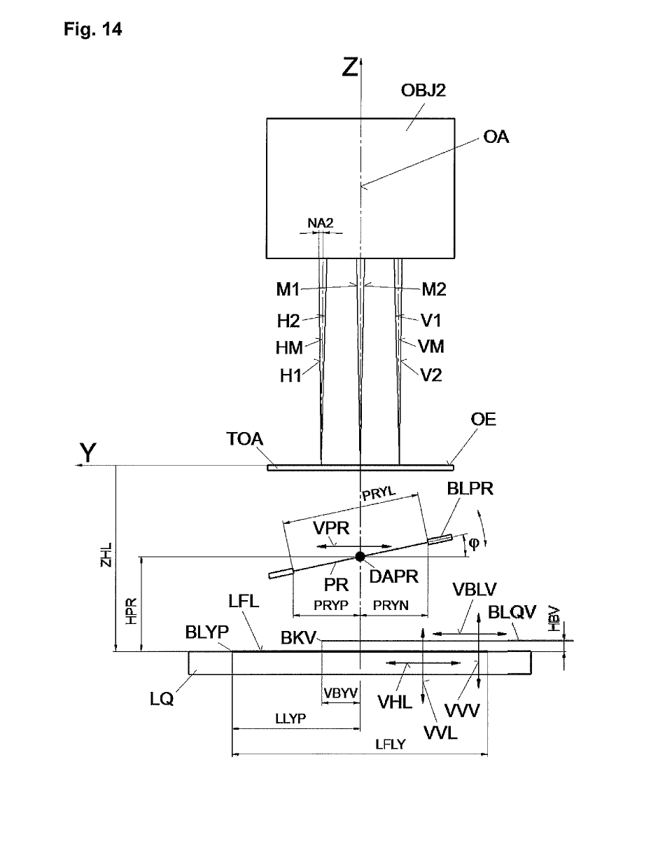

FIG. 14: shows a further exemplary embodiment of an apparatus according to the invention with a prism film and an additional diaphragm;

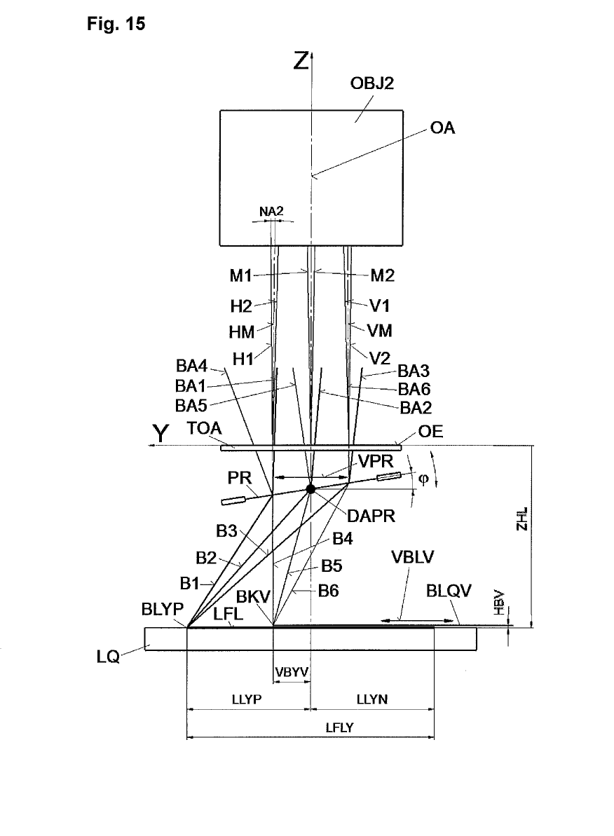

FIG. 15: shows a variant of the apparatus shown in FIG. 14;

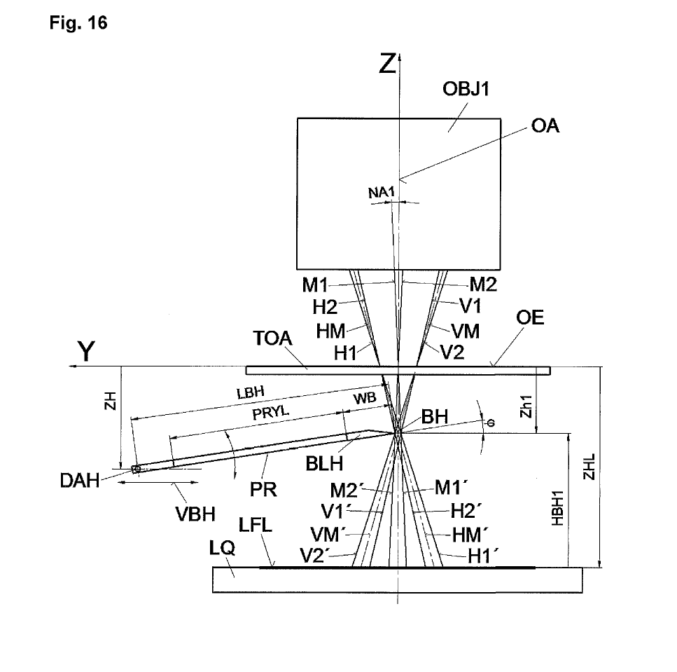

FIG. 16: shows an exemplary embodiment of an apparatus according to the invention, wherein the prism film is not optically effective;

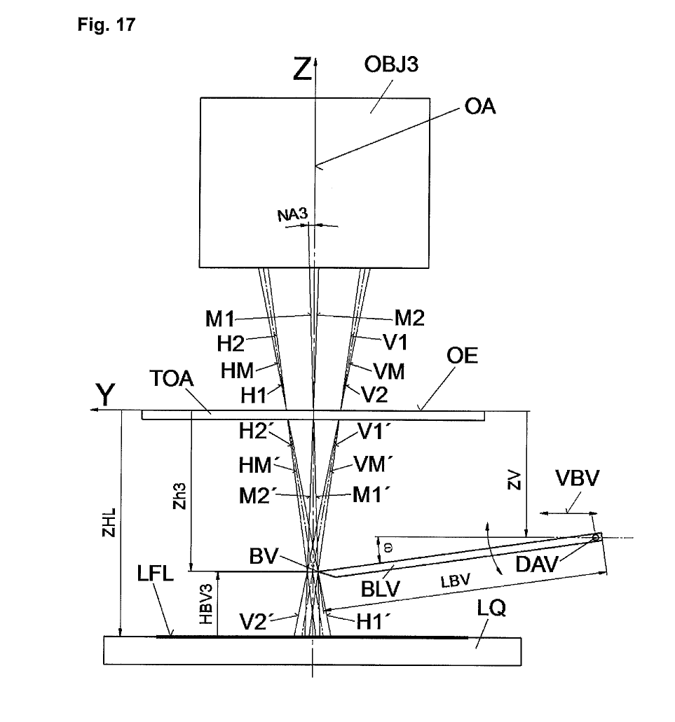

FIG. 17: shows a further exemplary embodiment of an apparatus according to the invention, wherein the prism film is not optically effective;

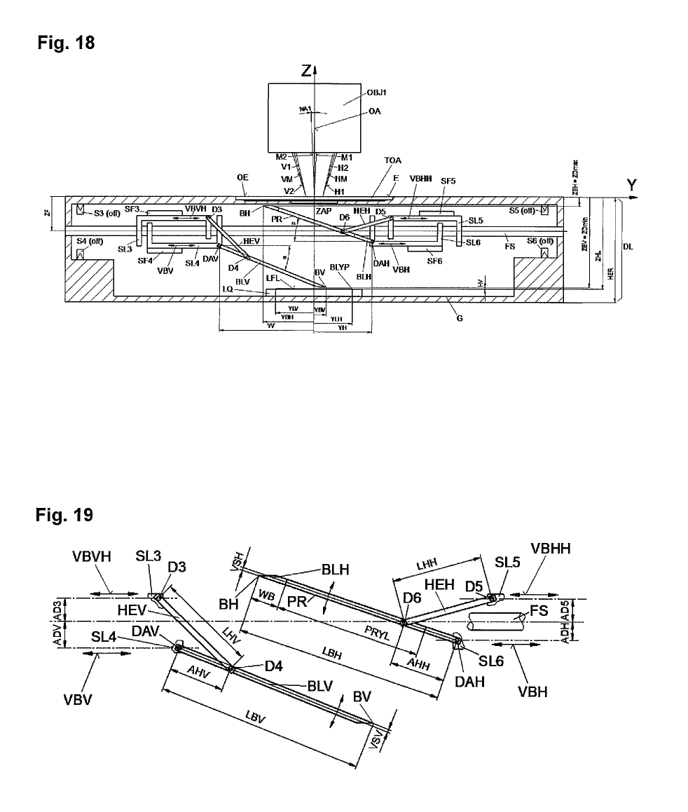

FIG. 18: shows an exemplary embodiment of an apparatus according to the invention with two diaphragm edges and a prism film; and

FIG. 19: shows a schematic illustration of the exemplary embodiment of FIG. 18.

Similar components and those which work similarly are provided with the same reference numerals in the drawings. Reference is also made to the list of reference numerals at the end of the description.

From the known data of different objectives OBJ1, OBJ2, OBJ3, the outermost rays/edge beams on the image side can be determined and depicted together with a back projection of these imaging outermost rays back into the illumination area, each in conjunction with a motorized zoom body MZK, in dependence upon the zoom factor β.

FIG. 3 shows the side view of the beam path with the objective OBJ1 of FIG. 1, which, together with the motorised zoom body MZK (not shown in FIG. 3) and the currently effective zoom factor β, has a numerical aperture NA1, an object field diameter OF1 in the object plane OE and a Z coordinate of the entrance pupil ZE1. The coordinate system with the axes X, Y and Z aids orientation.

Starting from the object plane OE, the boundary light beams are shown which are particularly relevant for the description of the illustration through the depicted lens OBJ1.

The light beams H1 and H2 as well as the middle light beam HM start from the rear object field edge, wherein the light beams H1 and H2 represent the theoretical aperture limitations of the objective OBJ1 as shown with the effective zoom factor β. Correspondingly the light beams V1, V2 and VM start from the front object field edge, and designate the theoretical aperture limits of the objective OBJ1 shown for the momentarily effective zoom factor β and the middle light beam VM.

In practical use there is generally a transparent object support TOA which produces, due to the refraction index differences and thickness, a beam offset, thus an extension of the actually effective optical distances. Both the optical effectiveness of the transparent object support TOA with a thickness DG and a refractive index nG as well as the corresponding optical properties of the object OB with an object height OH and a refractive index nO must be considered. Local curvatures of the object OB and/or refractive index fluctuations, for example through air bubbles inclusions etc., also lead to a change in the optical path and are to be considered in principle.

Due to the low cost objective-zoom body combinations typical in stereomicroscopy and macroscopy, there are no corrected pupil planes fixed over the zoom region and no guaranteed suitability for polarisation optical methods.

In addition, there are no defined entrance pupils which are fixed during zooming in the case of the described typical low-priced objective-zoom body combinations OBJ1 with MZK and OBJ3 with MZK. The fulfillment of such a requirement would have clearly made the optical design and the objective construction more difficult. This would have led at least to the objectives being more expensive and to a possibly unacceptable construction size, even if a solution to this were found at all. There are thus in practice no planar fixed-location entrance pupils with the usual minimised image errors. The entrance pupils are thus greatly deformed and migrate upon variation of the zoom factor β and the position of the entrance pupils depends greatly upon the light wavelength. If it is taken into consideration that the object support TOA has a non-negligible thickness DG, that the object OB hat an optically relevant thickness and that common zoom microscopes have a pupil which is not a well-defined even surface, it follows that an effective entrance pupil has a distance Zh1 from the object plane OE, which distance is displaced with respect to the z coordinate of the ideal entrance pupil ZEP1.

If a coded objective changer COW according to FIG. 1 is used, an identical object OB can be assumed to be present on an identical transparent object support TOA for different objectives OBJ1 and OBJ3 so that also Zh1 and Zh3 show corresponding differences.

In case of an image recorded through the right channel R of the objective OBJ1 with the arrangement according to FIG. 3, the contrast without further means is very weak, structures and/or phase differences are as good as unrecognisable. The image has, on the other hand, great homogeneity in relation to brightness.

In a first embodiment the image quality is improved by providing a diaphragm in the body of the transmitted light cover which can be displaced in the direction of the optical axis of the observation system. This diaphragm can be set with different zoom positions to the position of the entrance pupil of the optical system. Different contrast effects can be achieved through a displacement perpendicular to the optical axis.

FIG. 4 shows the front view, FIG. 5 the side view from the left of an arrangement according to the invention. The coordinate system with the axes X, Y and Z aids orientation. R1 to R6 are right light rays/beams in FIG. 4, and L1 to L6 designate left light beams.

FIG. 5 shows the boundary light beams starting from the object plane OE or the top side of the transparent object support TOA, which boundary light beams are particularly relevant to the description of the imaging of the depicted objective OBJ1.

The light beams H1 and H2 and the middle light beam HM come from the rear object field edge, wherein the light beams H1 and H2 represent the theoretical aperture limitations of the depicted objective OBJ1 with the momentarily effective zoom factor β. NA1 refers to the objective aperture of the objective OBJ1 in FIGS. 4 and 5.

Similarly, the light beams V1, V2 and VM come from the front object field edge, wherein V1 and V2 identify the theoretical aperture limitations of the objective OBJ1 shown with the currently effective zoom factor β.

All light beams projected back into the illumination space retain their respective name. Merely an apostrophe is added to indicate consideration of the beam offset SV. The middle light beams in the image space VM and HM thus result, in consideration of the beam offset through the transparent object support TOA according to FIG. 3, in the light beams VM′ and HM′ projected back into the illumination space. In FIGS. 5, M1 and M2 identify middle light beams.

According to the invention an adjustable diaphragm BL with a diaphragm edge BK is arranged in the installation space between the object plane OE or the upper side of the transparent object support TOA and the light surface LFL of a light source LQ, cf. FIG. 5. This diaphragm BL can be adjusted in height, i.e. set along the shift direction hVB in such a way that the diaphragm edge BK lies in an ideal Z diaphragm position Zh1 for the currently active objective OBJ1 in combination with a zoom body MZK, on which a current zoom factor β is set. It can be seen in FIG. 5 that this setting has already taken place, wherein this is only an idealised representation for the purpose of illustration of the principle.

As already set out, the entrance pupils of most objectives are not fixed in position on zoom systems, mainly for cost reasons, and do not comply with any special quality requirements. This leads to the position and form of the entrance pupil not being clearly defined. It is in part also highly dependent upon the light wavelength. The actual beam path is thus clearly more complex and correspondingly complicated to illustrate. In order to describe the main mode of operation, therefore, only the idealised beam path is used.

Due to the abovementioned complex conditions and further unknown influences of the object OB and its environment such as for example the transparent object support TOA, Petri dish with nutrient solution, practical trials to determine and/or set the ideal Z diaphragm position Zh1 are indispensable. Mainly on account of the unknown influences of the object OB and its environment, a suitable operating element is preferably provided, for example an adjust scroll wheel SADJ, is provided to allow the client to vary the diaphragm position perpendicular to the object plane OE.

The ideal diaphragm position is characterized in that at least one diaphragm BL can be freely positioned with at least one linearly extending diaphragm edge BK between the light source LQ and the object plane OE parallel to the surface normal of the object plane OE in the direction hVB and in at least one direction VB perpendicular thereto. The diaphragm BL with diaphragm edge BK can thus be brought through movement in direction hVB of the surface normal of the object plane OE in order to homogenise the illumination into an ideal diaphragm position Zh1, in which it can be optimally adjusted to the currently effective imaging system. The imaging system comprises a zoom body MZK with the current zoom factor β, an objective OBJ1, an object OB and possibly a transparent object support TOA. The contrast strength can be adjusted by displacing the diaphragm BL with the diaphragm edge BK perpendicular to the surface normal of the object plane OE in the direction VB, wherein the diaphragm edge BK is orientated parallel to the object plane OE and perpendicular to the displacement direction VB for the contrast level variation. In principle, no further means for homogenisation of the lighting are provided or required.

When the ideal Z diaphragm position Zh1 has been set, the distance between the lighting surface LFL and the diaphragm BL is then HB1; the distance ZHL results according to FIG. 5 from ZHL=ZH1 −HB1.

It can be seen in FIGS. 4 and 6 that the light area LFL of the light source LQ has an extension LFLX in X direction and IFLY in Y direction. For a vignetting-free homogeneous illustration using the objective OBJ1 shown with the momentarily effective zoom factor β, however, only the light area extensions LX in X direction and LY in Y direction are required.

Ideally, the light field dimensions LFLX and LFLY are selected to be at least large enough to allow a vignetting-free homogeneous lighting for each objective under all imaging conditions arising. The form of the light area can hereby be adapted to the actually effective back-projection of the light beams. This then results approximately in an ellipsis with large half-axis in the X direction during 3D observation, or a circle during 2D observation. 2D observation is hereby intended to mean single-channel observation of the sample. 3D observation is correspondingly observation with two channels.

By moving the diaphragm BL positioned at a distance Zh1 from the object plane OE or from the upper side of the transparent object support TOA in the displacement direction VB, the diaphragm BL can be brought into the illumination beam path with the diaphragm edge BK in such a way that certain light beams can be filtered out. The diaphragm is preferably moved along the Y axis as it then acts for the left channel L and the right channel R equally. FIG. 4 shows that a movement of the diaphragm (not shown) at a distance Zh1 in the X direction would not filter out the light beams of the two channels evenly. This would result in unsuitable illumination for 3D images. If the diaphragm BL with the diaphragm edge BK is brought into the illuminating beam path according to FIG. 5, that is to say by moving at a distance Zh1 from the object plane OE or from the top side of the transparent object support TOA, in the displacement direction VB, it does not only act on both channels evenly but instead also on all points of the object field.

According to the arrangement of the diaphragm BL in FIG. 5, the diaphragm edge BK contacts the back-projected light rays V2′ and H2′ which come from the opposing object field edges. All back-projected light beams are thus contacted between the opposing object field edges by the diaphragm edge BK. If the diaphragm BL is pushed further into the illumination beam path, this results in an even cover of illuminating light beams over the object field, that is to say the lighting remains homogeneous with decreasing brightness, whereby the contrast clearly improves. This was confirmed through practical trials. The further operation and effects will be described in detail with the following figures with an idealized depiction of the beam propagation.

FIG. 6 shows by way of example the determined curves for the ideal Z diaphragm positions Zh to the three objectives OBJ1, OBJ2, OBJ3 of FIG. 1 in dependence upon the zoom factor β of the motorised zoom body MZK used in relation to the XYZ coordinate system, of which the origin lies in the object plane OE. The curves respectively begin with the smallest zoom factor βmin and end at the largest zoom factor βmax of the zoom body MZK of FIG. 1.

The ideal Z diaphragm positions of the two curves Kh1 and Kh3 of the corresponding objectives OBJ1 and OBJ3 lie, with typical curve form in the XYZ coordinate system between ZDmin and ZDmax which corresponds to the region, in which a height-adjustable diaphragm can be constructively realised. These boundaries thus characterise the usable installation space for the contrast method according to the invention within the transmitted light device DL according to the invention. In normal use, the uppermost diaphragm position ZDmax is defined by the transparent object support TOA in the transmitted light device DL. The diaphragm may not contact the transparent object support TOA from below under any circumstances. The lowermost diaphragm position ZDmin results from the limited construction height HER of the transmitted light device DL in FIG. 1, which must remain below a certain height for ergonomic reasons. The housing of the transmitted light device DL of FIG. 1 has a height HER of approximately 100 mm. A transmitted light illumination device DL without further accessories should not be higher.

The minimum ideal Z diaphragm positions of the curves Kh1 and Kh3 are called Zh1min and Zh3min. Accordingly the maximum ideal Z diaphragm positions of these curves are called Zh1max and Zh3max.

The lowest/minimum ideal diaphragm z position of the upper curve part Kh2o is indicated with Kh2omin and the highest/maximal ideal diaphragm z position of the lower curve part Kh2u is indicated with Kh2umax.

The objective OBJ2 of FIG. 1 has a substantially different curve progression which is typical for certain objectives OBJ. It can be seen in FIG. 6 that the curve for the objective OBJ2 comprises two curve sections Kh2o and Kh2u. Between these curve sections, in case of a zoom factor βP2, there is a pole position, i.e. the curve progression springs here from the top curve section Kh2o from plus infinity to the lower curve section Kh2u towards minus infinity.

Ideal diaphragm positions in Z direction for magnifications β1, β2 to β13 are indicated with f2(1), f2(2) to f2(13) and these have been determined with the objective OBJ2 on the motorised zoom body MZK.

The minimum and maximum ideal Z diaphragm positions of the curve sections Kh2u and Kh2o, i.e. Zh2min and Zh2max, are thus infinite or lie practically so far apart that the corresponding ideal Z diaphragm position can no longer be constructively set. In the upper curve section Kh2o, the ideal Z diaphragm position is at any rate unreachable, as the diaphragm BL with the diaphragm edge BK would have to be arranged above the object plane OE. In the lower curve section Kh2u the ideal Z diaphragm layer can be initially ensured only from the zoom factor βG2 and is then precisely in the boundary position ZDmin. The described contrasting method between the zoom factors βmin and βG2 cannot therefore be used with all advantages. Another suitable contrasting method is preferably to be determined for this.

It was illustrated using FIG. 6 that the objective OBJ2 of FIG. 1 has a fundamentally different curve pattern from that of the objectives OBJ1 and OBJ3. The curve pattern of objective OBJ2 is typical for a certain number of further objectives OBJ.

In order to illustrate this problem, the boundary light beams are shown in FIGS. 7 and 8 starting from the object plane OE or from the top side of the transparent object support TOA, these boundary light beams being particularly relevant for the description of the image through the objective OBJ2 shown.

The light beams H1 and H2 and the middle light beam HM come from the rear object field edge, wherein the light beams H1 and H2 represent the theoretical aperture limitations of the depicted objective OBJ1 with the momentarily effective zoom factor β. NA2 refers to the objective aperture of the objective OBJ2 in FIGS. 7 and 8.

Similarly, the light beams V1, V2 and VM come from the front object field edge, wherein V1 and V2 identify the theoretical aperture limitations of the objective OBJ1 shown with the currently effective zoom factor β.

It can be seen in FIGS. 7 and 8 that the light area LFL of the light source LQ has an extension LFLX in X direction and IFLY in Y direction. For a vignetting-free homogeneous illustration using the objective OBJ2 shown with the momentarily effective zoom factor β, however, only the light area extensions LX in X direction and LY in Y direction are required.

The illustrations in FIGS. 7 and 8 refer to a motorised zoom body MZK with an objective OBJ2 according to FIG. 1, wherein βP2 is effective as the current zoom factor according to FIG. 6.

It can be easily recognised from FIGS. 7 and 8 that there is no accessible ideal Z diaphragm position in the available installation space, in which a diaphragm BL with a diaphragm edge BK according to FIG. 5 could be meaningfully arranged. The insertion of a diaphragm in the X or Y direction would lead, due to the light beams hereby filtered out, to a darkening in the corresponding object field region, that is to say the illumination would be highly inhomogeneous due to the unilateral illumination. For example, the incorporation of a diaphragm from the positive Y direction would initially completely filter out the rear light beams H1, HM and H2, whereby the rear limit of the object field would be totally darkened.

The problem of the inaccessible illumination pupil is circumvented by the use of a prism film to change the light distribution.

The distance ZHL from the light area LFL to the object plane OE or the upper side of the transparent object support TOA is additionally identified here.

FIG. 10 shows the view of FIG. 8, wherein the back-projected light beams are not shown. According to the invention means are provided between the light source LQ and the transparent object support TOA which convey the illuminating light into a different light distribution.

At a distance HPR from the light area LFL of the light source LQ, there is the rotation axis DAPR, about which a prism film PR can be rotated or tilted. Due to the current angle of inclination φ with respect to the object plane OE, the effective length of the prism film PRYL can also be described as a projection onto the object plane OE or the Y axis. The proportion of PRYL on the positive Y half-axis is PRYP, the proportion of PRYL on the negative Y half-axis is identified by PRYN.

FIG. 11 shows an enlarged detailed view of the prism film PR and illustrates its working principle. The light beam STE entering along the optical axis OA meets the main flank HF of a micro prism PRM comprising a micro prism structure PRS with the division TE and the prism angle ε. The light beam leaves the prism film PR as an outgoing light beam STA at a deflection angle δ with respect to the optical axis OA, that is to say relative to its original direction as an incident beam STE. The micro prisms PRM respectively also have a subsidiary flank NF which, together with the main flank, in practice brings about a certain beam deflection. With the inclination φ of the prism film PR, not only the deflection angle δ changes through the beams STE deflected via the main flank HF, but also the light portions between the main flank HF and the subsidiary flank NF. In addition the transitions between the main flanks HF and the subsidiary flanks NF are respectively identified by rapid angle changes which also bring about advantageous contrasting effects.

Due to the plurality of adjacent micro prism structures PRS, this deflection behaviour also applies to light beams which are incident in parallel.

According to the invention for example a prism film PR of the type IDF II of the company 3M can be used. It consists of a carrier material TM, to which a micro prism structure PRS comprising micro prisms PRM is applied, so that a total thickness of t results. With this arrangement, with an angle of inclination φ of the prism film PR of 0°, the deflection angle δ is approximately 20°. The structure of the prism film thereby continues in the X direction.

In order to illustrate the function, FIG. 12 shows the measured deflection characteristic, published by 3M, of the IDF II prism film PR. The previously described deflection characteristic in FIG. 11 applies only to the main propagation direction STA of the illuminating light subject to the precondition of an incident light beam STE, orientated perpendicularly to the light area LFL, on the solely effective main flank HF of the micro prism PRM comprising the micro prism structure PRS. Starting from a light source LQ, the illustration in FIG. 12 shows two intensity curves over the angle according to the prism film:
the light distribution of a light source LQ without prism film; curve: “backlight”,
the light distribution of the same light source LQ with orientation of the deflection to the left; curve: “IDF II Left Directing”.

The prism film PR is advantageously orientated so that the deflection is always inclined away from the user in such a way that dazzling can be excluded. This corresponds according to FIG. 10 to a deflection into the YZ plane with positive half-axes. In the illustration of FIG. 12 therefore only one direction is considered: the orientation of the deflection to the left; curve: “left directing”.

The light distribution for the redistributed illuminating light has a main propagation direction STA which differs from the original main propagation direction of the illuminating light STE. The direction of the middle axis of the imaging optical path OA deviates from the direction of the main propagation direction of the redistributed illuminating light STA which shines through the object by the deflection angle δ. An inclined light illumination from one side is thereby achieved. That is to say, a clearly recognisable asymmetrical light distribution is produced from an originally symmetrical light distribution. The light distribution does not cause any fundamental limitation of the angle spectrum compared with the original main propagation direction of the illuminating light OA, but instead only an intensity lowered to a clearly reduced base level GN in certain angle regions and a light amplification in the remaining angle region between the front limit VOB and the rear limit HIB.

The large maximum difference between the different levels of the light intensity (MPR in relation to GN) of closely adjacent angle regions (from VOB to approximately OA) leads, in combination with the inclined light illumination, to a clearly visible contrast enhancement.

In addition the prism film PR causes, in a relatively large angle region, through the redistribution of the illuminating light, a light amplification LV compared with the maximum level MLQ of the light intensity of the light source LQ without prism film PR. That is to say, certain light portions which would completely disappear with normal filtering-out, are used through the redistribution for a brightness and contrast enhancement. The base level GN of the light intensity at least present in all relevant angle regions and the good mixing of the light beams from different regions of the micro prism structure PRS ensure homogeneous illumination with a transmitted light-bright field characteristic. In spite of the deflection via the prism film PR through refraction, the mixing over different regions of the micro prism structure PRS also leads to an illumination which is homogeneous in terms of colour.

A plateau width PB of the light intensity of the redistributed illuminating light around the main propagation direction STA between the plateau edges PMI and PRA is also indicated in FIG. 12. PMI thereby identifies the edge of the plateau width PB which has the shorter distance from the original main propagation direction STE. On the other hand PRA identifies the edge of the plateau width PB which has the greater distance from the original main propagation direction STE. PB is defined by the reduction or increase in the light intensity to the value MLQ.

The advantages described in relation to FIG. 12 can be achieved in a particular way if the prism film PR is orientated so that the micro prism structure PRS points towards the light source LQ. If the micro prism structure PRS is orientated in the direction of the object plane OE, a middle beam deflection is indeed produced which corresponds approximately to the angle δ, but the light distribution according to FIG. 12 then no longer applies. The application of the prism film PR according to the invention thus advantageously refers to an orientation of the micro prism structure PRS in the direction of the light source LQ. In this orientation, the contrast can be varied with the angle φ, as the deflection characteristic of the prism film PR hereby changes within the usable range. This change in the deflection characteristic via the angle φ is very advantageous as it is only through this that an optimal adaptation to different optical imaging systems can be achieved, that is to say to different combinations of objective OBJ and zoom body MZK with zoom factor β. Practical trials have shown that the optimal settings for the angle φ are so different for different optical imaging systems that a uniform setting with a fixed angle φ for this would be disadvantageous. A contrast improvement would indeed be achieved but the deflection characteristic would not yet be optimal.

FIG. 12 shows only an angle region of +/−60°. Through trials it has been ascertained that with a light source LQ which radiates light in the whole angle range of +−/90°, in the case of use according to the invention of an IDF II prism film PR together with this light source LQ, a certain base brightness is also still present in the two edge angle regions between 60° and 90°.

A high intensity white light LED surface light with a directed illumination characteristic, that is to say it does not radiate light evenly in all directions, provides particularly good contrasts. The light intensity decreases instead with increasing deviation from the axis orientated perpendicularly to the light area LFL. This applies in particular for the edge regions. A light distribution thereby results which is still relatively similar, with an indicated nominal value of +/−30° for the angle range, to the light distribution of the curve “backlight” in FIGS. 7 and 8 (light source without prism film PR). Also with this light source LQ, when the prism film PR is used according to the invention in the whole angle region +/−90°, at least a certain base brightness is present. This has been confirmed through trials.

FIGS. 13 and 14 show possibilities for influencing the starting illumination in order to further increase the contrast. For this, only the relevant side views from the left are shown. The same reference numerals apply as in the previously described figures.

It can be recognised in FIG. 13 that the proportion LFLY of the light area LFL effective in the Y direction is additionally limited by a rear diaphragm BLQH and a front diaphragm BLQV. The rear diaphragm BLQH can be positioned in the displacement directions VBLH and VVH in such a way that its diaphragm edge BKH is arranged at a distance HBH from the light area LFL and at a distance VBYH from the optical axis OA. Similarly, the front diaphragm BLQV can be positioned in the displacement directions VBLV and VVV so that its diaphragm edge BKV is arranged at a distance HBV from the light area LFL and at a distance VBYV from the optical axis OA. It is to thereby be observed that the two diaphragm edges BKH and BKV lie in the direction of the positive Y half-axis. Through suitable positioning of the diaphragm edges BKH and BKV, the effective illumination can be adapted to the current optical system environment so that a clearly visible contrast improvement results.

FIG. 14 shows a modified variant, in which one of the two adjustable diaphragms can be omitted. In this case, the rear diaphragm BLQH is omitted. Instead, the light source LQ can be positioned in the displacement directions VHL and VVL. The rear edge of the effective light area LFL thereby acts as a diaphragm edge BLYP. LED surface lights which can be used as a light source LQ usually have a sheet metal housing which ends with the light area and can thus be used as a diaphragm edge BLYP. It is to be observed that when the light source LQ is positioned in the displacement direction VVL, the distance HBV from the light area LFL to the front diaphragm BLQV also changes. That is to say, this distance must possibly be corrected once more afterwards. All other descriptions and functions correspond to those of FIG. 13.

By way of a third embodiment, however, an array of light sources in the light source LQ is conceivable, said array being selectively switched on and off in order to achieve the diaphragm effects.

FIG. 15 shows, on the basis of FIG. 14, a simplified possibility for increasing the contrast with an illustration of the corresponding main propagation directions of the illuminating light starting from the effective diaphragm edges BLYP (illuminating light beams B1, B2, B3) and BKV (illuminating light beams B4, B5, B6). In contrast with FIG. P14 a possibility of positioning the light source LQ is omitted, that is to say the diaphragm edge BLYP is in a fixed position. In addition the distance HBV is selected to be as small as structurally justifiable so that the front diaphragm BLQV, when positioning in the displacement direction VBLV, does not in any case grind on the light area LFL or on adjacent housing parts of the light source LQ. This distance HBV can be fixedly pre-set in structural terms so that a displacement possibility of the front diaphragm BLQV perpendicularly to the light area LFL can be omitted. The effective light area in the Y direction LFLY is thus reduced through the front diaphragm edge BKV and the light field limit BLYP in the Y direction.

LLYN indicates the expansion of the light area LFL in the negative Y direction here and LLYP indicates the expansion in the positive Y direction.

The distance from BLYP to the optical axis OA is LLYP here. The distance from BKV to the optical axis OA is VBYV. It is again to be observed that the two effective diaphragm edges BLYP and BKV lie in the direction of the positive Y half-axis.

The corresponding illuminating light beams BA1 to BA6 deflected by the prism film PR which can be displaced in the direction VPR result from the illuminating light beams B1 to B6, wherein these illuminating light beams BA1 to BA6 reproduce, for rough orientation, only the main propagation direction of the illuminating light according to the prism film. It can be recognised in FIG. 15 that the back-projected beams V1, VM, V2, M1, OA, M2, H1, HM, H2, which are characteristic for the imaging through the objective OBJ2 when using the motorised zoom body MZK with the set zoom factor β and the resulting effective aperture NA2, lie within the angle region. This angle region spans across the two deflected illuminating light beams which result from the two illuminating light beams starting from the two diaphragm edges BLYP and BKV.

Through the additionally effective narrowing of the light area LFL, certain light portions which predominantly do not cause or constitute usable scattered light can be filtered out. This has been demonstrated by trials. The contrast-increasing light distribution through the micro prism structure PRS pointing according to the invention to the light source LQ is principally maintained with a minimum base brightness. That is to say, the filtering-out of individual light portions does not lead to an inhomogeneous illumination and/or to resolution losses.

As the impairing light portions can change with the optically effective system environment, it is advantageous if at least the front diaphragm BLQV can be freely positioned in the displacement direction VBLV.

The FIGS. 18 and 19 show an embodiment of a transmitted light device DL in the right system as seen from the observer according to FIG. 1, i.e., the X axis points to the right, the Y axis points rearwards, the Z axis points upwards; comprising a detailed view of the lever mechanics. The same reference signs still apply.

This exemplary embodiment is characterized in that the two diaphragm/carriage systems are maintained in principle so that the contrast method can continue to be used with the height-adjustable diaphragm. However, the means for contrasting according to the invention are now in the diaphragm BLH, thus the prism film PR according to the invention. The whole arrangement according to the invention with prism film PR corresponds to the optical operating principle which was previously described using FIGS. 10, 11, 12, 15.

With the change in the Z coordinate ZBH of the diaphragm BLH, the angle φ between the prism film PR and the object plane OE also changes so that the prism film can be tilted according to the invention about a rotation axis parallel to the object plane. This rotation axis is now called DAH. Having regard to its operating principle, however, it is comparable with the previously described rotation axis DAPR, so that the field of protection of this application also includes the rotation axis DAH.

It can be recognised in FIG. 19 that the prism film has an effective length PRYL. There is an effective diaphragm width WB between the prism film PRYL and the diaphragm edge BH. This diaphragm width WB is preferably dimensioned so that coverage of the beam cross-section is still possible without the prism film PRYL notably impairing the function of a contrast method, wherein the diaphragm edge is positioned in dependence upon an effective entrance pupil in the direction of the optical axis.

The two diaphragms are moved via respectively two carriages, namely SL3 and SL4 and also SL5 and SL6. In order to detect the position of the carriages, a respective position sensor S3, S4, S5 and S6 and respectively an auxiliary position sensor S5H and S6H are present. Through switching flags SF3, SF4, SF5 and SF6, the position of the carriages relative to the position sensors S3, S4, S5 and S6 can be ascertained.

In the position of the carriages shown in FIG. 18, the position sensors S3, S4, S5 and S6 are not triggered and are accordingly “off”.

The following are also indicated: D3 indicates a rotation axis for a lever HEV, via which the carriage SL3 is connected to the diaphragm BLV, wherein the rotation axis D3 is located at the connection point between the lever HEV and the carriage SL3; D4 indicates a rotation axis for the lever HEV at the connection to the diaphragm BLV; D5 indicates a rotation axis for a lever HEH, via which the carriage SL5 is connected to the diaphragm BLH, wherein the rotation axis D5 is located at the connection point between the lever HEH and the carriage SL5, and D6 indicates a rotation axis for the lever HEH at the connection to the diaphragm BLH.

LHH describes the length of the rear lever HEH between the rotation axes D5 and D6. LHV identifies the length of the front lever HEV between the rotation axes D3 and D4.

FS indicates a guide path of a linear guide, e.g. via a guide rod. The carriages SL3, SL4, SL5 and SL6 can be moved on the guide path FS. The guide path is located at the Z coordinate ZF in relation to the object support.

The rear diaphragm can be displaced for variation of the contrast transversely to the optical axis OA. This is achieved through a synchronous movement of the carriages SL5 and SL6 along the displacement direction VBH or VBHH.

The same applies correspondingly to the front diaphragm, whereby the displacement directions VBV and VBHV are indicated in FIG. 18.

The components of the transmitted light device DL are arranged in a housing G.

In addition, FIG. 19 shows the distance AD3 between the guide path FS and the rotation axis D3 and the distance AD5 between the guide path FS and the rotation axis D5. ADV identifies the distance between the guide path FS and the rotation axis DAV, while ADH indicates the distance between the guide path FS and the rotation axis DAH. Furthermore the lever length AHH between the rotation axes DAH and D6 and the lever length AHV between the rotation axes DAV and D4 are indicated.

YH and ZH (see also FIGS. P16 and P17) identify the momentary Y and Z coordinates of the rear rotation axis DAH. YBH indicates the momentary Y coordinate of the rear diaphragm edge BH. YBV identifies the momentary Y coordinate of the front diaphragm edge BV and YBV identifies the momentary Y coordinate of the front diaphragm edge BV. YV and ZV identify the momentary Y and Z coordinates of the front rotation axis DAV.

In addition, accessories ZAP, or the interface for them, which can optionally be inserted in an adapter plate AP, are shown. The accessories ZAP can be for example polarisation filters, insert diaphragms or colour filters.

FIGS. 16 and 17 show the operating principle of the device according to the invention according to FIGS. 18 and 19, thus when using a contrast method, wherein a diaphragm edge is positioned in the direction of the optical axis for setting the contrast, for the two different objectives OBJ1 and OBJ3. The prism film PR integrated in the diaphragm BLH is not thereby optically effective in this application. The same reference numerals and descriptions as those of the previously shown figures continue to apply.

FIG. 16 additionally shows the height distance HBH1, which defines the distance from the light area LFL to the rear diaphragm edge BH in the ideal Z diaphragm position for the objective OBJ1 on the zoom body MZK with the current zoom factor β.

Correspondingly, FIG. 17 shows with HBV3 the height distance from the light area to the front diaphragm edge BV in the ideal Z diaphragm position for the objective OBJ3 on the zoom body MZK with the current zoom factor β.

FIG. 16 further indicates with LBH the distance between the rear diaphragm edge BH and the pivot point DAH of the rear diaphragm BLH. Similarly, in FIG. 17, LBV indicates the distance between the front diaphragm edge BV and the pivot point DAV of the front diaphragm BLV.

The settable Z diaphragm coordinates of the two diaphragm-slide systems can also cover different regions of the complete setting options of the Z diaphragm edge coordinates, so that the installation space between ZDmin and ZDmax is split into two regions.

In another variant at least larger partitions or the whole installation space between ZDmin and ZDmax of the two diaphragms can be used, so that it can be chosen in the regions common to both diaphragms whether a regular diaphragm orientation without an azimuth angle is set, or a diaphragm orientation that is inverted, i.e. rotated about 180°, relative to the regular azimuth orientation is set.

An image which has been recorded through the right channel R of the objective OBJ2 with an arrangement according to FIGS. 7 and 8, wherein there are no means according to the invention for contrast enhancement between the light source LQ and the object plane OE, and wherein a zebrafish preparation with carrier glass is used as the object OB, has relatively low contrast. Hardly any structures and/or phase objects can be recognised.

If further images are recorded with the same object OB and the same optically effective objective-zoom body combination comprising objective OBJ2, zoom body MZK with zoom factor β, these images can be directly compared with each other.

An image of the object, wherein a usual VisiLED HCT base, which works with a diaphragm which can only be displaced in the Y direction in a fixed Z coordinate, was used for illumination, is highly inhomogeneous. It is only in a transition zone between a lower dark and an upper bright image region that the contrast has improved in relation to the image which was recorded without means according to the invention for contrast enhancement.

In the case of an image, for which the device according to the invention was used for illumination with an optical path as shown in FIGS. 10, 11, 12, 18, 19, and wherein the diaphragm BLV shown in FIGS. 18 and 19 was moved completely out of the optical path, so that it was not effective during the camera recording, the image is still homogeneous. In relation to the image which was recorded without means according to the invention for contrast enhancement, however, the contrast has clearly improved.

This was achieved through the following adjustment method:

The diaphragm BLH of FIGS. 18 and 19 is positioned so that the prism film PR is preferably irradiated without trimming. Subsequently, the Z coordinate ZBH is varied so that the contrast acquires a maximum value.

In the case of an image of the object, wherein the device according to the invention with an optical path as in FIGS. 10, 11, 12, 15, 18, 19 is used for illumination, and wherein the diaphragm BLV shown in FIGS. 18 and 19 was effective during recording by the camera, the image is still homogeneous. In relation to the image which was recorded without means according to the invention for contrast enhancement, however, the contrast has very greatly improved.

This was achieved through the following adjustment method:

The diaphragm BLH of FIGS. 18, 19 is positioned so that the prism film PR is preferably irradiated without trimming. Subsequently, the Z coordinate ZBH is varied so that the contrast acquires a maximum value.

After that, the diaphragm edge BV with constant Z coordinate ZBV=ZDmin is brought out of the negative Y direction into the optical path until a colour vignetting at the image edge becomes visible. Subsequently, the Z coordinate ZBH is varied again so that the contrast acquires a maximum value and the diaphragm BV with constant Z coordinate ZBV=ZDmin is again moved so far out of the optical path until the vignetting is no longer visible in the image.

With the invention a method for transmitted light illumination is provided which is suited in particular for illuminating low-contrast transmitted light objects on stereo microscopes and macroscopes. In addition, applications of this method in transmitted light devices are described.

The invention provides a cost-effective transmitted light-bright field illumination method which is suited in particular for illuminating low-contrast transmitted light objects in the smaller overview magnifications on stereo microscopes and macroscopes. The method provides a very homogeneous illumination, does not significantly limit the resolution capacity and provides adequate illumination intensities. In addition, it can also be used with a low structural height of the transmitted light device without visible impairments and is preferably suited for objectives, of which the ideal Z diaphragm positions are at a greater distance from the object support and/or possibly lie above it. Furthermore, the illumination method according to the invention can be combined with other illumination methods which are suited for accessible ideal Z diaphragm positions, so that all illumination methods can be applied in a single transmitted light device. Finally, the favourable illumination settings can also be easily set and reproduced for untrained users. In addition the method is also suited for cost-effective objective-zoom body combinations which do not have corrected pupil planes which are fixed over the zoom range and do not compulsorily have to be usable for polarisation optical methods.

### LIST OF REFERENCE SYMBOLS

AD3 Distance between the guide path FS and the rotation axis D3
AD5 Distance between the guide path FS and the rotation axis D5
ADH Distance between the guide path FS and the rotation axis DAH
ADV Distance between the guide path FS and the rotation axis DAV
AHH Lever length between the rotation axes DAH and D6
AHV Lever length between the rotation axes DAV and D4
α Adjustment angle of the deflecting mirror SP
ASPH Aspheric illumination optic
β Currently effective zoom factor of the zoom body
β1 Support point No. 1 between βmin and βmax for the description of the zoom factor curves via approximation functions
β2 Support point No. 2 between βmin and βmax for the description of the zoom factor curves via approximation functions
β3 Support point No. 3 between βmin and βmax for the description of the zoom factor curves via approximation functions
β4 Support point No. 4 between βmin and βmax for the description of the zoom factor curves via approximation functions
β5 Support point No. 5 between βmin and βmax for the description of the zoom factor curves via approximation functions
β6 Support point No. 6 between βmin and βmax for the description of the zoom factor curves via approximation functions
β7 Support point No. 7 between βmin and βmax for the description of the zoom factor curves via approximation functions
β8 Support point No. 8 between βmin and βmax for the description of the zoom factor curves via approximation functions
β9 Support point No. 9 between βmin and βmax for the description of the zoom factor curves via approximation functions
β10 Support point No. 10 between βmin and βmax for the description of the zoom factor curves via approximation functions
β11 Support point No. 11 between βmin and βmax for the description of the zoom factor curves via approximation functions
β12 Support point No. 12 between βmin and βmax for the description of the zoom factor curves via approximation functions
βmax Maximal settable zoom factor
βmin Minimal settable zoom factor
βP2 Zoom factor at which the curve for the objective No. 2 has a pole position
B1 Illuminating light border ray 1
B2 Illuminating light border ray 2
B3 Illuminating light border ray 3
B4 Illuminating light border ray 4
B5 Illuminating light border ray 5
B6 Illuminating light border ray 6
BA1 Illuminating light border ray 1 after passing through the prism film PR
BA2 Illuminating light border ray 2 after passing through the prism film PR
BA3 Illuminating light border ray 3 after passing through the prism film PR
BA4 Illuminating light border ray 4 after passing through the prism film PR
BA5 Illuminating light border ray 5 after passing through the prism film PR
BA6 Illuminating light border ray 6 after passing through the prism film PR
BE Operating unit for the whole system
BH Diaphragm edge rear
BK Diaphragm edge
BKL Diaphragm edge left
BKR Diaphragm edge right
BL Diaphragm
BLH Rear diaphragm
BLL Left diaphragm
BLQH Rear diaphragm
BLQV Front diaphragm
BLR Right diaphragm
BLV Front diaphragm
BLYP Limiting edge of the illuminating area in the positive Y direction
BMAB Operating element for motorised aperture diaphragm MAB
BMFT Operating element for the motorised focussing device
BMPR Structure width of the micro prisms of the prism film PR
BMZK Operating element for the motorised zoom body
BV Diaphragm edge front
BWI Angle between the border rays STL and STR of the illumination
COW Coded objective changer
δ Deflection angle through the tilted prism film PR
D3 Rotation axis for the lever HEV at the slide SL3
D4 Rotation axis for the lever HEV at the diaphragm BLV
D5 Rotation axis for the lever HEH at the slide SL5
D6 Rotation axis for the lever HEH at the diaphragm BLH
DA Rotation axis
DAPR Rotation axis of the prism film PR
DAH Rotation axis rear diaphragm
DAV Rotation axis front diaphragm
DG Thickness of the transparent object support TOA or the glass plate
dl Transmission light intensity difference for characterizing the gradient
DL Transmitted light device
dW Transmission angle region for characterizing the gradient
ε Prism angle of the micro prisms of the prism film PR
E Plane at the level of the object support on the transmitted light device; this plane is generally formed through the upper side of the transmitted light device
EM Electronic module for controlling the whole system (signal processing, etc.)
f2(1) Ideal diaphragm position in Z direction for the objective OBJ2 on the motorised zoom body MZK at the support point No. 1, i.e. at β1
f2(2) Ideal diaphragm position in Z direction for the objective OBJ2 on the motorised zoom body MZK at the support point No. 2, i.e. at β2
f2(3) Ideal diaphragm position in Z direction for the objective OBJ2 on the motorised zoom body MZK at the support point No. 3, i.e. at β3
f2(4) Ideal diaphragm position in Z direction for the objective OBJ2 on the motorised zoom body MZK at the support point No. 4, i.e. at β4
f2(5) Ideal diaphragm position in Z direction for the objective OBJ2 on the motorised zoom body MZK at the support point No. 5, i.e. at β5
f2(6) Ideal diaphragm position in Z direction for the objective OBJ2 on the motorised zoom body MZK at the support point No. 6, i.e. at β6
f2(7) Ideal diaphragm position in Z direction for the objective OBJ2 on the motorised zoom body MZK at the support point No. 7, i.e. at β7
f2(8) Ideal diaphragm position in Z direction for the objective OBJ2 on the motorised zoom body MZK at the support point No. 8, i.e. at β8
f2(9) Ideal diaphragm position in Z direction for the objective OBJ2 on the motorised zoom body MZK at the support point No. 9, i.e. at β9
f2(10) Ideal diaphragm position in Z direction for the objective OBJ2 on the motorised zoom body MZK at the support point No. 10, i.e. at β10
f2(11) Ideal diaphragm position in Z direction for the objective OBJ2 on the motorised zoom body MZK at the support point No. 11, i.e. at β11
f2(12) Ideal diaphragm position in Z direction for the objective OBJ2 on the motorised zoom body MZK at the support point No. 12, i.e. at β12
f2(13) Ideal diaphragm position in Z direction for the objective OBJ2 on the motorised zoom body MZK at the support point No. 13, i.e. at β13
FE Guidance elements
FF Front area of the light conductor LL
FS Guide path of a linear guide, e.g. via a guide rod
G Housing
GN Base level of the illumination over the prism film PR
H1 Rear light beam 1
H1′ Rear light beam 1 with beam offset through transparent object support TOA or glass plate
H2 Rear light beam 2
H2′ Rear light beam 2 with beam offset through transparent object support TOA or glass plate
HB1 Height distance from the light area LFL to the diaphragm BL in the ideal Z diaphragm position for the objective OBJ1 on the zoom body MZK with the current zoom factor β
HBH Height distance from the light area LFL to the rear diaphragm BLQH in the ideal Z diaphragm position for the current objective OBJ on the zoom body MZK with the current zoom factor β
HBH1 Height distance from the light area LFL to the rear diaphragm BLQH in the ideal Z diaphragm position for the objective OBJ1 on the zoom body MZK with the current zoom factor β
HBHw3 Height distance from the light area LFL to the rear diaphragm BLQH in the horizontal position
HBV Height distance from the light area LFL to the front diaphragm BLQV in the ideal Z diaphragm position for the current objective OBJ on the zoom body MZK with the current zoom factor β
HEH Lever rear
HER Ergonomically justifiable construction height of the transmitted light device DL
HEV Lever front
HF Main flank of the micro prism PRM
HIB Rear limit of the light intensity increase
HL Distance from the light area LFL to the object plane OE or to the upper side of the transparent object support TOA
HM Rear middle light beam
HM′ Rear middle light beam with beam offset through transparent object support TOA or glass plate
HPR Distance from the light area LFL to the prism film PR or to the rotation axis DAPR
HV Height distance of the front diaphragm from the light area according to the exemplary embodiment
hVB Displacement direction for adapting the diaphragm edge to the ideal Z diaphragm position
φ Angle of inclination of the prism film PR in relation to the object plane OE and possibly inclination of the diaphragm, in which the prism film PR is arranged or could be arranged
K Camera for documentation
Kh1 Curve representing the ideal diaphragm position for OBJ1 on MZK in dependence upon β
Kh2o Upper curve section representing the ideal diaphragm position for OBJ2 on MZK in dependence upon β (between βmin and βP2)
Kh2omin Smallest value of the upper curve section Kh2o
Kh2u Lower curve section representing the ideal diaphragm position for OBJ2 on MZK in dependence upon β (between βP2 and βmax)
Kh2umax Greatest value of the lower curve section Kh2u
Kh3 Curve representing the ideal diaphragm position for OBJ3 on MZK in dependence upon β
KLD Cold light source for supply of light to the transmitted light device DL
L Left image channel
L1 Left light beam 1
L1′ Left light beam 1 with beam offset through transparent object support TOA or glass plate
L2 Left light beam 2
L2′ Left light beam 2 with beam offset through transparent object support TOA or glass plate
L3 Left light beam 3
L3′ Left light beam 3 with beam offset through transparent object support TOA or glass plate
L4 Left light beam 4
L4′ Left light beam 4 with beam offset through transparent object support TOA or glass plate
L5 Left light beam 5
L5′ Left light beam 5 with beam offset through transparent object support TOA or glass plate
L6 Left light beam 6
L6′ Left light beam 6 with beam offset through transparent object support TOA or glass plate
LB Effective length of the diaphragm BL
LBH Distance between the rear diaphragm edge BH and the pivot point DAH of the rear diaphragm BLH
LBV Distance between the front diaphragm edge BV and the pivot point DAV of the front diaphragm BLV
LFL Light area of the light source LQ
LFLX Expansion of the light area LFL in X direction
LFLY Expansion of the light area LFL in Y direction
LHH Length of the rear lever HEH between the rotation axes D5 and D6
LHV Length of the front lever HEV between the rotation axes D3 and D4
LL Light conductor
LLYN Expansion of the light area LFL in negative Y direction
LLYP Expansion of the light area LFL in positive Y direction
LM Left mid-light beam
LM′ Left mid-light beam with beam offset through transparent object support TOA or glass plate
LO Uppermost edge of the lamellae film
LQ Light source
LV Light amplification through the prism film PR
LX Light area expansion in the X direction for consideration of the objective edge beams
LY Light area expansion in the Y direction for consideration of the objective edge beams
LYN Effective expansion of the light source in negative Y direction
M1 Middle light beam 1
M1′ Middle light beam 1 with beam offset through transparent object support TOA or glass plate
M2 Middle light beam 2
M2′ Middle light beam 2 with beam offset through transparent object support TOA or glass plate
MFT Motorised focussing device
MLQ Brightness maximum with light source LQ, i.e. without prism film PR
MPR Brightness maximum with prism film PR
MZK Motorised zoom body
nG Refractive index of the transparent object support TOA
nO Refractive index of the object OB
NA1 Numerical aperture of objective No. 1
NA2 Numerical aperture of objective No. 2
NF Subsidiary flank of the micro prism PRM
OA Optical axis of the objective
OB Object
OBJ Objective
OBJ1 Objective No. 1
OBJ2 Objective No. 2 with EP remote from OE
OBJ3 Objective No. 3
OE Object plane (without object identical to the object support)
OF, OF1, OF2 Diameter of the object field to be illuminated
OH Height of the object OB incl. the ambient medium (e.g. Petri dish with nutrient solution) from the object support, or from the upper side of the transparent object support TOA, to the object plane OE
OK Ocular
PB Plateau width of the light intensity of the redistributed illuminating light around the main propagation direction STA between PMI and PRA
PMI Edge of the plateau width PB which is at the shorter distance from the original main propagation direction STE; PB is defined by the decrease or increase in the light intensity to the value MLQ
PR Prism film
PRA Edge of the plateau width PB which is at the greater distance from the original main propagation direction STE; PB is defined by the decrease or increase in the light intensity to the value MLQ
PRM Micro prism
PRS Micro prism structure
PRYL Effective length of the prism film PR
PRYP Effective length of the prism film PR in positive Y direction
PRYN Effective length of the prism film PR in negative Y direction
R Right image channel
R1 Right light beam 1
R1′ Right light beam 1 with beam offset through transparent object support TOA or glass plate
R2 Right light beam 2
R2′ Right light beam 2 with beam offset through transparent object support TOA or glass plate
R3 Right light beam 3
R3′ Right light beam 3 with beam offset through transparent object support TOA or glass plate
R4 Right light beam 4
R4′ Right light beam 4 with beam offset through transparent object support TOA or glass plate
R5 Right light beam 5
R5′ Right light beam 5 with beam offset through transparent object support TOA or glass plate
R6 Right light beam 6
R6′ Right light beam 6 with beam offset through transparent object support TOA or glass plate
RM Right mid-light beam
RM′ Right mid-light beam with beam offset through transparent object support TOA or glass plate
S3 Position sensor for the carriage 3
S3 (off) Non-activated position sensor S3 for the carriage 3
S3 (on) Activated position sensor S3 for the carriage 3
S4 Position sensor for the carriage 4
S4 (off) Non-activated position sensor S4 for the carriage 4
S4 (on) Activated position sensor S4 for the carriage 4
S5 Position sensor for the carriage 5
S5 (off) Non-activated position sensor S5 for the carriage 5
S5 (on) Activated position sensor for the carriage 5
S5H Auxiliary position sensor for the carriage SL5
S5H (off) Non-activated auxiliary position sensor S5H for the carriage 5
S5H (on) Activated auxiliary position sensor S5H for the carriage 5
S6 Position sensor for the carriage 6
S6 (off) Non-activated position sensor S6 for the carriage 6
S6 (on) Activated position sensor S6 for the carriage 6
S6H Auxiliary position sensor for the carriage 6
S6H (off) Non-activated auxiliary position sensor S6H for the carriage 6
S6H (on) Activated auxiliary position sensor S6H for the carriage 6
SADJ Adjust scroll wheel
SF3 Switching flag 3 for activating position sensor S3
SF4 Switching flag 4 for activating position sensor S4
SF5 Switching flag 5 for activating position sensor S5 and possibly auxiliary position sensor S5H
SF6 Switching flag 6 for activating position sensor S6 and possibly auxiliary position sensor S6H
SL3 Carriage 3
SL4 Carriage 4
SL5 Carriage 5
SL6 Carriage 6
SP Deflection mirror
SR1 Operating element 1 in the transmitted light device DL
SR2 Operating element 2 in the transmitted light device DL
SR3 Operating element 3 in the transmitted light device DL
ST1 Light beam 1
ST2 Light beam 2
ST3 Light beam 3
ST4 Light beam 4
ST5 Light beam 5
STA Exiting light beam
STE Incoming light beam
SV Beam offset
t Thickness of the prism film PR
T Objective barrel
TE Division of the micro prism structure PRS
TM Carrier material for micro prisms of the prism film PR
TOA Transparent object support
TR Carrier
V1 Front light beam 1
V1′ Front light beam 1 with beam offset through transparent object support TOA or glass plate
V2 Front light beam 2
V2′ Front light beam 2 with beam offset through transparent object support TOA or glass plate
VB Displacement direction of the diaphragm BL
VBH Displacement direction of the rear diaphragm for contrast variation
VBHH Displacement direction of the lever adjustment for the rear diaphragm
VBL Displacement direction of the left diaphragm
VBLH Displacement direction of the rear diaphragm parallel to the light area LFL
VBLV Displacement direction of the front diaphragm parallel to the light area LFL
VBR Displacement direction of the right diaphragm
VBV Displacement direction of the front diaphragm
VBVH Displacement direction of the lever adjustment for the front diaphragm
VBYH Displacement of limiting edge of the rear diaphragm
VBYV Displacement of limiting edge of the front diaphragm
VHL Displacement direction of the light source LQ parallel to the light area LFL
VM Front mid-light beam
VM′ Front mid-light beam with beam offset through transparent object support TOA or glass plate
VOB Front limit of the light intensity increase
VPR Displacement direction of the prism film PR
VR Displacement direction
VSH Offset between the plane which spans through the pivot point axes DAH, D6 and the rear diaphragm edge BH
VSV Offset between the plane which spans through the pivot point axes DAV, D4 and the front diaphragm edge BV
VVH Displacement direction of the rear diaphragm perpendicular to the light area LFL
VVL Displacement direction of the light source LQ perpendicular to the light area LFL
VVV Displacement direction of the front diaphragm perpendicular to the light area LFL
VYH Displacement direction of limiting edge of the rear diaphragm according to the exemplary embodiment
VYV Displacement of limiting edge of the front diaphragm according to the exemplary embodiment
ω Angle of inclination of the front diaphragm BLV in relation to the object plane OE
WB Effective diaphragm width
X X coordinate axis of the XYZ coordinate system
Y Y coordinate axis of the XYZ coordinate system
YH Y coordinate of the rear rotation axis DAH
YBH Y coordinate of the rear diaphragm edge BH
YBV Y coordinate of the front diaphragm edge BV
YLH Y coordinate of the rear light area limit
YLV Y coordinate of the front light area limit
YMH Y coordinate of the rear diaphragm edge set by motor
YMV Y coordinate of the front diaphragm edge set by motor
YV Y coordinate of the front rotation axis DAV
Z Z coordinate axis of the XYZ coordinate system
ZAP Accessories which can optionally be inserted in the adapter plate AP or the interface for this (e.g. polarisation filters, insert diaphragms, colour filters, etc.)
ZBH Z coordinate of the rear diaphragm edge BH
ZBV Z coordinate of the front diaphragm edge BV
ZDmax Z coordinate of the uppermost diaphragm position which can be constructively realised
ZDmin Z coordinate of the lowermost diaphragm position without table which can be constructively realised
ZEP1 Z coordinate of the entrance pupil for objective No. 1 in the current zoom magnification
ZEP2 Z coordinate of the entrance pupil for objective No. 2 in the current zoom magnification
ZEP3 Z coordinate of the entrance pupil for objective No. 3 in the current zoom magnification
ZF Z coordinate of the guide path-reference axis
Zh Z coordinate of the diaphragm edge BK in the ideal Z diaphragm position for the current objective in the current zoom magnification
Zh1 Z coordinate of the diaphragm edge in the ideal Z diaphragm position for the objective No. 1 in the current zoom magnification
Zh1max Maximum value of Zh for objective No. 1 Zh1min Minimum value of Zh for objective No. 1
Zh2 Z coordinate of the diaphragm edge BK in the ideal diaphragm position for objective No. 2 in the current zoom magnification
Zh2max Maximum value of Zh for objective No. 2
Zh2min Minimum value of Zh for objective No. 2
Zh3 Z coordinate of the diaphragm edge BK in the ideal Z diaphragm position for objective No. 3 in the current zoom magnification
Zh3max Maximum value of Zh for objective No. 3
Zh3min Minimum value of Zh for objective No. 3
ZH Z coordinate of the rear rotation axis DAH
ZHL Z coordinate of the light area LFL
ZMH Z coordinate of the rear diaphragm edge set by motor
ZMV Z coordinate of the front diaphragm edge set by motor
ZV Z coordinate of the front rotation axis DAV

1-25. (canceled)

26. A transmitted light illumination apparatus for light microscopes, comprising
a light source adapted to emit an illuminating light bundle,
a holding device for holding a sample to be examined, and
a deflection device for contrast adjustment, the deflection device being arranged between the light source and the holding device and adapted for varying an angle distribution of the illuminating light bundle relative to an optical axis,
wherein the deflection device comprises a prism film.

27. The apparatus as defined in claim 26,
wherein
the prisms of the prism film point in the direction of the light source.

28. The apparatus as defined in claim 26,
wherein
a main deflection direction of the deflection device is different from the optical axis.

29. The apparatus as defined in claim 26,
wherein
the deflection device is rotatable about a rotation axis orientated transversely to the optical axis and oriented parallel to the direction of the prism edges.

30. The apparatus as defined in claim 26,
wherein
means for variable positioning of the deflection device in at least one of:
a direction transversely to the optical axis and
in the direction of the optical axis are provided.

31. The apparatus as defined in claim 26,
wherein
means are provided for moving the deflection device out of an optical path of the illuminating light and for moving the deflection device into the optical path of the illuminating light.

32. The apparatus as defined in claim 26,
wherein
the prisms of the prism film have a prism angle of 20° to 30°.

33. The apparatus as defined in claim 26,
wherein
at least one diaphragm edge to trim the illuminating light bundle is provided,
the diaphragm edge is arranged between the holding device and the light source,
the diaphragm edge extends transversely to an optical axis of a light microscope,
which can be positioned in an operating state on the transmitted light illumination apparatus, and
in order to adapt the optical path of the illuminating light to an effective entrance pupil of the objective means for variable positioning of the diaphragm edge in direction of the optical axis are provided, and
a position of the diaphragm edge in the direction of the optical axis can be varied.

34. The apparatus as defined in claim 33,
wherein
the diaphragm edge is an edge of a mechanical diaphragm and the deflection device is formed at the mechanical diaphragm.

35. The apparatus as defined in claim 26,
wherein
for varying an effective light surface of the light source at least one further diaphragm is provided which is positioned directly next to the light source.

36. The apparatus as defined in claim 26,
wherein
a carriage mechanism with a first carriage and a second carriage is provided and adapted for displacing at least one of
the diaphragm edge, and
the deflection device
in the direction of the optical axis and in the direction transversely to the optical axis.

37. The apparatus as defined in claim 33,
wherein
the diaphragm edge asymmetrically trims the illuminating light bundle.

38. The apparatus as defined in claim 26,
wherein
the light source is a planar light source.

39. A transmitted light illumination method for light microscopes,
in which a sample held by a holding device is exposed to illuminating light from a light source,
in which an angle distribution of the illuminating light bundle can be varied with a deflection device for contrast adjustment, and
in which the deflection device comprises a prism film.

40. The method as defined in claim 39,
wherein
the method further comprises the step of adjusting an inclination angle of the deflection device to each momentarily set combination of an objective, a zoom body and a zoom factor.

41. The method as defined in claim 39,
wherein
the deflection device is tilted during operation such that the illumination light bundle is tilted away from a user.

42. The method as defined in claim 39,
wherein
an illuminating light bundle emitted from the light source is trimmed by a diaphragm edge arranged between the holding device and the light source.

43. The method as defined in claim 42,
wherein
the diaphragm edge is positioned in a direction transversely to the optical axis in order to set the contrast.

44. The method as defined in claim 42,
wherein
the diaphragm edge is positioned in a plane of the effective entrance pupil of the objective.

45. The method as defined in claim 42,
wherein
the diaphragm edge is moved out of an optical path of the illuminating light and for moving the deflection device into the optical path of the illuminating light if an effective entrance pupil of the objective lies outside an area accessible to the diaphragm edge.

46. The method as defined in claim 39,
wherein
settings of at least one of:
the deflection device,
the at least one diaphragm edge, and
further diaphragms
are realised in an automated manner.

47. The method as defined in claim 39,
wherein
adjustments of at least one of:
the deflection device,
the at least one diaphragm edge,
further diaphragms, and
further optical components
are carried out in an automated manner in dependence upon a determined configuration of components that are present.

48. A microscope system with a light microscope and a transmitted light illumination apparatus as defined in claim 26.

49. The microscope system as defined in claim 48,
wherein
a control device is provided which is connected to components of the light microscope and the transmitted light illumination apparatus and which is configured to control the microscope and the transmitted light illumination apparatus to carry out a transmitted light illumination method for light microscopes, in which the sample held by the holding device is exposed to illuminating light from the light source,
in which the angle distribution of the illuminating light bundle can be varied with the deflection device for contrast adjustment, and
in which the deflection device comprises the prism film.

50. The microscope system as defined in claim 48,
wherein
a memory device is provided, in which settings of the transmitted light device and of the microscope, comprising settings of the at least one diaphragm edge, are stored.
